(19) United States
(12) Patent Application Publication
(10) Pub. No.: US 2026/0046092 A1
(43) Pub. Date: Feb. 12, 2026

(54) ORTHOGONAL COVER CODE SEQUENCE APPLICATION FOR A TRANSPORT BLOCK OVER MULTIPLE SLOTS

(71) Applicant: Lenovo (Singapore) Pte. Limited, Singapore (SG)

(72) Inventors: Sher Ali Cheema, Ilmenau (DE); Ahmed Hindy, Aurora, IL (US); Ali Ramadan Ali, Kraiburg (DE)

(73) Assignee: Lenovo (Singapore) Pte. Limited, Singapore (SG)

(21) Appl. No.: 18/798,609

(22) Filed: Aug. 8, 2024

(51) Int. Cl. H04L 5/00

(52) U.S. Cl. CPC H04L 5/0053; H04L 5/0016

(57) ABSTRACT

Various aspects of the present disclosure relate to orthogonal cover code (OCC) sequence application for a transport block over multiple slots (TBoMS). An apparatus, such as a UE, receives first signaling that schedules a physical uplink shared channel (PUSCH) transmission that includes a transport block (TB) over a set of slots. The UE receives signaling that indicates one or more parameters associated with at least one OCC sequence. The UE applies the at least one OCC sequence to the PUSCH transmission based on the one or more parameters within respective slots of the set of slots, the at least one OCC sequence is applied to the PUSCH transmission for the respective slots of the set of slots, or both. The UE transmits the PUSCH transmission using the slots.

### TECHNICAL FIELD

The present disclosure relates to wireless communications, and more specifically to applying codes to transmissions.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive first signaling that schedules a physical uplink shared channel (PUSCH) transmission including a transport block (TB) over a set of slots, receive second signaling that indicates one or more parameters associated with at least one orthogonal cover code (OCC) sequence, apply the at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, and transmit the PUSCH transmission during the set of slots.

In some implementations of the method and apparatuses described herein, the UE repeats, based on a length of the at least one OCC sequence and the at least one OCC sequence being applied to the PUSCH transmission for the respective symbols of the respective slots of the set of slots, the at least one OCC sequence is applied to the PUSCH transmission for the respective slots of the set of slots, or both, uplink data associated with the PUSCH transmission on a set of frequency resources or time resources. Additionally, or alternatively, the UE repeats, based on a length of the at least one OCC sequence, uplink data associated with at least one of the respective symbols of the set of slots or respective sets of symbols of the set of slots, and where the one or more parameters indicate for the UE to apply the at least one OCC sequence to the PUSCH transmission for the respective symbols of the respective slots of the set of slots, the PUSCH transmission includes a set of repetitions of the uplink data associated with the respective symbols or the respective sets of symbols, and the set of repetitions are associated with resource blocks in a frequency domain. Additionally, or alternatively, the set of slots is associated with a same OCC sequence, and the set of slots is associated with a same repetition type. Additionally, or alternatively, the one or more parameters indicate one or more of a set of OCC sequences corresponding to the respective slots of the set of slots or a set of repetition types corresponding to the respective slots of the set of slots.

Additionally, or alternatively, the one or more parameters indicate for the UE to apply the at least one OCC sequence to the PUSCH transmission for the respective slots of the set of slots based on the transport block or a code block (CB) associated with the transport block, the set of slots includes a first portion of slots allocated for the transport block and a second portion of slots allocated for repetitions of uplink data associated with the PUSCH transmission, and a numerical quantity of slots in the first portion of slots is based on a length of the at least one OCC sequence. Additionally, or alternatively, respective slots of the first portion of slots are associated with a same symbol allocation, and the respective slots of the first portion of slots are associated with a same OCC sequence. Additionally, or alternatively, the UE determines to transmit at least one repetition based on at least one slot of the second portion of slots being within an inactive period of a discontinuous reception cycle associated with the UE and at least one slot of the first portion of slots being within an active period of the discontinuous reception cycle associated with the UE, or determines to cancel transmission of at least one repetition based on at least one slot of the second portion of slots being within an active period of a discontinuous reception cycle associated with the UE and at least one slot of the first portion of slots being within an inactive period of the discontinuous reception cycle associated with the UE.

Additionally, or alternatively, a length of the at least one OCC sequence is based on a length associated with the set of slots. Additionally, or alternatively, a slot offset associated with the set of slots is zero and respective redundancy versions (RVs) associated with the set of slots are a same value. Additionally, or alternatively, the UE determines, based on one or more of a length of the at least one OCC sequence or a numerical quantity of slots of the set of slots allocated for repetitions of uplink data associated with the PUSCH transmission, a TB size (TBS) associated with the TB, where the at least one OCC sequence is associated with one or more of a time domain or a frequency domain. Additionally, or alternatively, the one or more parameters indicate the length of the at least one OCC sequence. Additionally, or alternatively, the one or more parameters include one or more of a first parameter that indicates multiple types of OCC sequences are enabled or disabled, a second parameter that indicates a length of the at least one OCC sequence, a third parameter that indicates an index of the at least one OCC sequence in a list of OCC sequences, or a fourth parameter that indicates one or more repetition types associated with repeating uplink data associated with the PUSCH transmission. Additionally, or alternatively, to receive the second signaling, the UE receives at least one of radio resource control (RRC) signaling, a downlink control information (DCI) message, or a medium access control-control element (MAC-CE) that indicates the one or more parameters. Additionally, or alternatively, to receive the second signaling, the UE receives RRC signaling that indicates a set of parameters including the one or more parameters and receives a DCI message or MAC-CE that activates the one or more parameters.

Some implementations of the method and apparatuses described herein may further include a processor for wireless communication to receive first signaling that schedules a PUSCH transmission including a TB over a set of slots, receive second signaling that indicates one or more parameters associated with at least one OCC sequence, apply the at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, and transmit the PUSCH transmission during the set of slots.

Some implementations of the method and apparatuses described herein may further include a method performed by a UE, the method including receiving first signaling that schedules a PUSCH transmission including a TB over a set of slots, receiving second signaling that indicates one or more parameters associated with at least one OCC sequence, and apply the at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, transmitting the PUSCH transmission during the set of slots.

Some implementations of the method and apparatuses described herein may include a NE for wireless communication to transmit first signaling that schedules a PUSCH transmission including a TB over a set of slots, transmit second signaling that indicates one or more parameters associated with applying at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, and receive the PUSCH transmission during the set of slots.

In some implementations of the method and apparatuses described herein, the uplink data associated with the PUSCH transmission is repeated on a set of frequency resources or time resources based on a length of the at least one OCC sequence and the at least one OCC sequence being applied to the PUSCH transmission for the respective symbols of the respective slots of the set of slots, the at least one OCC sequence is applied to the PUSCH transmission for the respective slots of the set of slots, or both. Additionally, or alternatively, uplink data associated with at least one of the respective symbols of the set of slots or respective sets of symbols of the set of slots is repeated based on a length of the at least one OCC sequence, the one or more parameters indicate to apply the at least one OCC sequence to the PUSCH transmission for the respective symbols of the respective slots of the set of slots, the PUSCH transmission includes a set of repetitions of the uplink data associated with the respective symbols or the respective sets of symbols, and the set of repetitions are associated with resource blocks in a frequency domain. Additionally, or alternatively, the set of slots is associated with a same OCC sequence, and the set of slots is associated with a same repetition type. Additionally, or alternatively, the one or more parameters indicate one or more of a set of OCC sequences corresponding to the respective slots of the set of slots or a set of repetition types corresponding to the respective slots of the set of slots.

Additionally, or alternatively, the one or more parameters indicate to apply the at least one OCC sequence to the PUSCH transmission for the respective slots of the set of slots based on the transport block or a CB associated with the transport block, the set of slots includes a first portion of slots allocated for the transport block and a second portion of slots allocated for repetitions of uplink data associated with the PUSCH transmission, and a numerical quantity of slots in the first portion of slots is based on a length of the at least one OCC sequence. Additionally, or alternatively, respective slots of the first portion of slots are associated with a same symbol allocation, and the respective slots of the first portion of slots are associated with a same OCC sequence. Additionally, or alternatively, a length of the at least one OCC sequence is based on a length associated with the set of slots. Additionally, or alternatively, a slot offset associated with the set of slots is zero and respective RVs associated with the set of slots are a same value.

Additionally, or alternatively, the one or more parameters indicate a length of the at least one OCC sequence. Additionally, or alternatively, the one or more parameters include one or more of a first parameter that indicates multiple types of OCC sequences are enabled or disabled, a second parameter that indicates a length of the at least one OCC sequence, a third parameter that indicates an index of the at least one OCC sequence in a list of OCC sequences, or a fourth parameter that indicates one or more repetition types associated with repeating uplink data associated with the PUSCH transmission. Additionally, or alternatively, to transmit the second signaling, the NE transmits at least one of RRC signaling, a DCI message, or a MAC-CE that indicates the one or more parameters. Additionally, or alternatively, to transmit the second signaling, the NE transmits RRC signaling that indicates a set of parameters including the one or more parameters and transmits a DCI message or MAC-CE that activates the one or more parameters.

### BRIEF DESCRIPTION OF THE DRAWINGS

FIGS. 1 and 2 illustrate examples of wireless communications systems in accordance with aspects of the present disclosure.

FIGS. 3 through 18 illustrate examples of resource diagrams, in accordance with aspects of the present disclosure.

FIG. 19 illustrates an example of a signaling diagram, in accordance with aspects of the present disclosure.

FIG. 20 illustrates an example of a UE in accordance with aspects of the present disclosure.

FIG. 21 illustrates an example of a processor in accordance with aspects of the present disclosure.

FIG. 22 illustrates an example of a NE in accordance with aspects of the present disclosure.

FIG. 23 illustrates a flowchart of a method performed by a UE in accordance with aspects of the present disclosure.

FIG. 24 illustrates a flowchart of a method performed by a NE in accordance with aspects of the present disclosure.

### DETAILED DESCRIPTION

Devices in a wireless communications system, such as UEs and NEs, transmit and receive signaling using communication resources (e.g., time-frequency resources and/or spatial resources). There may be a finite number of resources available to the devices for the communication. Thus, the devices may apply codes or code sequences, such as OCCs or OCC sequences, to the communication to provide for multiple devices to transmit and/or receive concurrently on the same communication resource without creating interference between the communication. To apply the codes, the devices select a code from a defined set of codes and use the code to multiply data symbols or bits to spread a signal over a greater set of communication resources, which increases the resistance of the signal to interference and improves data security. In some cases, OCC sequences have zero cross-correlation when aligned (e.g., OCC sequences are orthogonal), such that multiple signals may be transmitted simultaneously without interfering with each other.

The devices in the wireless communications system may implement signal repetition to improve communication reliability and signal quality. For example, the devices may duplicate data bits, symbols, or entire data packets and send them consecutively or at different time intervals. However, the use of repetitions reduces the communication capacity of the wireless communications system and throughput for individual devices by reducing the communication resources available for the communications. Further, the use of repetitions increases a transmission time for UEs, therefore increasing a use of uplink resources in the time domain before the uplink resources are released to other users. In some examples, to increase the communication capacity and/or throughput of the wireless communications system, the devices in the wireless communications system may multiplex signaling using OCC sequences. For example, the devices may apply the OCC sequences to the frequency and/or time resources of a transmission. However, the devices may not be provided with instructions that indicate how to apply the OCC sequences.

As described herein, a NE may transmit signaling to a UE that includes one or more parameters that indicate how the UE is to apply the OCC sequences to an uplink transmission (e.g., a PUSCH transmission). The signaling may include RRC signaling, a MAC-CE, and/or a DCI message that dynamically indicates the parameters. Additionally, or alternatively, the signaling may include RRC signaling that indicates a set of parameters, and a MAC-CE and/or DCI message that activates one or more parameters of the set of parameters. In some cases, the parameters may indicate for the UE to apply the OCC sequence within a slot (e.g., to individual symbols of a slot), which is referred to as intra-symbol OCC application. For example, the UE may apply the OCC sequence to a PUSCH transmission, such that uplink data and corresponding repetitions of the uplink data are repeated on frequency resources for respective symbols of the slot. Additionally, or alternatively, the parameters may indicate for the UE to apply the OCC sequence across a slot (e.g., to respective slots), which is referred to as intra-slot OCC application. For example, the UE applies the OCC sequence to a PUSCH transmission, such that uplink data and corresponding repetitions of the uplink data are repeated on time resources for respective symbols and/or slots. The UE may transmit the PUSCH transmission on the time resources (e.g., the symbols and/or slots) and the frequency resources.

In some examples, the NE may transmit signaling to the UE that schedules a PUSCH transmission that includes a TB over multiple slots, referred to as a TB over multiple slots (TBoMS) transmission. The parameters may indicate for the UE to apply the OCC sequence to the PUSCH transmission within respective slots of the plurality of slots, across the respective slots of the plurality of slots, or both. Additionally, or alternatively, the parameters may indicate for the UE to apply the OCC sequence to CB segments of the TB or to the entire TB.

In some examples, the NE may transmit signaling to the UE that indicates for the UE to perform frequency hopping according to a frequency offset (e.g., a numerical quantity of frequency resources, including RBs). The parameters may indicate for the UE to apply the OCC sequence to repetitions in a PUSCH transmission that are separated by the frequency offset. For example, the UE may apply one or more OCC sequences within respective slots, across the slots, or both for frequency hopping within the slot or across multiple slots.

By enabling one or more of intra-symbol or intra-slot OCC sequence application at one or more UEs (e.g., for a PUSCH transmission, for TBoMS, and/or with frequency hopping), multiple UEs may transmit uplink transmissions concurrently on same time-frequency resources without creating interference, which leads to reduced signaling overhead related to retransmissions resulting from the interference, while increasing signaling throughput for the wireless communications system. For example, by combining multiple OCC application methods (e.g., intra-symbol, intra-slot, and inter-slot), a higher number of UEs may be multiplexed on same time-frequency resources, which increases system capacity and signaling throughput compared to using a single OCC application method. The flexible application of OCC sequences across both time and frequency domains enables more efficient use of available resources.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

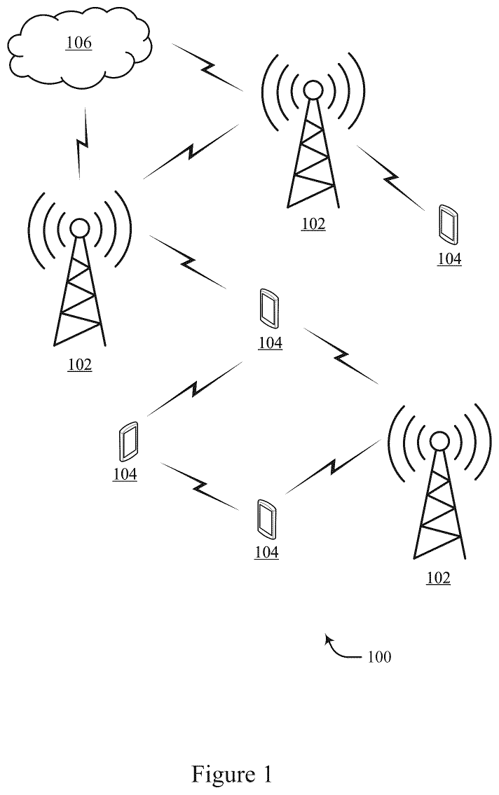

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives signaling from an NE 102 that indicates one or more parameters related to applying at least one OCC sequence to a PUSCH transmission. The UE 104 may receive additional signaling that schedules the PUSCH transmission over multiple slots, such as if the PUSCH transmission includes a TB (e.g., TBoMS). Additionally, or alternatively, the UE 104 may receive additional signaling that indicates for the UE 104 to perform frequency hopping using a frequency offset. The parameters may indicate for the UE 104 to enable OCC sequences within respective slots of the PUSCH transmission (e.g., intra-symbol OCC application), across respective slots of the PUSCH transmission (e.g., intra-slot OCC application), or both. Additionally, or alternatively, the parameters may indicate an index of one or more OCC sequences in a list or in a table, a length of the OCC sequences, or both. The UE 104 may apply the OCC sequences to the PUSCH transmission according to the parameters, which can account for the TB being scheduled over multiple slots and/or the frequency hopping. The UE 104 may transmit the PUSCH transmission to an NE 102 (e.g., a base station, gNB).

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

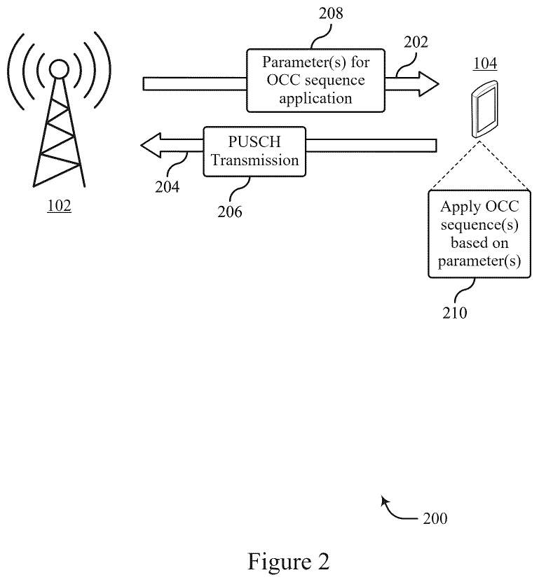

FIG. 2 illustrates an example of a wireless communications system 200 in accordance with aspects of the present disclosure. In some examples, the wireless communications system 200 implements or is implemented by aspects of the wireless communications system 100. For example, the wireless communications system 200 may include a UE 104 and a NE 102, which may be examples of a UE 104 and a NE 102 as described with reference to FIG. 1. The UE 104 and the NE 102 can exchange (e.g., transmit and/or receive) signaling using one or more communication links. For example, the UE 104 receives signaling, including control information and/or data, from the NE 102 via a downlink communication link 202, while the NE 102 receives signaling, including control information and/or data, from the UE 104 via an uplink communication link 204.

In some examples, a UE 104 can transmit an uplink transmission, which can include control signaling and/or data, to the NE 102 via the uplink communication link 204. For example, the UE 104 can transmit a PUSCH transmission 206 to the NE 102 via the uplink communication link 204. The PUSCH transmission 206 may include data and, optionally, uplink control information (UCI). A NE 102 may transmit signaling to the UE 104 scheduling one or more time-frequency resources for the PUSCH transmission 206, including one or more RBs and symbols within a slot or multiple slots. For example, the NE 102 may dynamically schedule the PUSCH transmission 206 using a DCI message on a downlink control channel (e.g., a physical downlink control channel (PDCCH), or semi-statically schedule the PUSCH transmission 206 using RRC signaling. A slot may refer to a basic time unit for scheduling in the wireless communications system 200. A slot includes a numerical quantity of symbols (e.g., 14 symbols or 12 symbols). A duration of a slot depends on a subcarrier spacing. An RB may refer to a unit of resources allocated in the frequency domain. An RB includes multiple consecutive subcarriers (e.g., 12 consecutive subcarriers) in the frequency domain and spans one slot in the time domain. In some examples, a size of an RB in the frequency domain may be fixed (e.g., 180 kHz, regardless of the subcarrier spacing). A RE may include one subcarrier during one symbol interval, where an RB includes a numerical quantity of resource elements, depending on the numerical quantity of symbols in a slot.

The UE 104 can use a waveform to transmit the PUSCH transmission 206, where a waveform defines a signal structure and modulation scheme. Example waveforms can include, but are not limited to, a cyclic prefix-OFDM (CP-OFDM) waveform, a DFT-spread-OFDM (DFT-s-OFDM) waveform, and an OFDMA waveform, among others. The UE 104 can process the PUSCH transmission 206, such as by performing TB cyclic redundancy check (CRC) attachment, CB segmentation, CB CRC attachment, channel coding (e.g., using a low-density parity-check (LDPC) code), rate matching, scrambling, modulation, layer mapping, and resource mapping. Example modulation schemes can include, but are not limited to, quadrature phase shift keying (QPSK) and quadrature amplitude modulation (QAM) (e.g., 16QAM, 64QAM and 256QAM).

In some cases, the UE 104 uses the CP-OFDM waveform, which includes the use of orthogonal subcarriers in a frequency domain, with a cyclic prefix added in the time domain to mitigate inter-symbol interference. The UE 104 may apply a DFT-spreading function before OFDM modulation, enabling single carrier-frequency division multiple access (SC-FDMA) transmission to reduce a peak-to-average power ratio (PAPR) of the signal. The UE 104 modulates data symbols and maps the modulated data symbols to respective subcarriers in the frequency domain. For a PUSCH transmission 206 using multiple antennas, the data symbols are precoded according to a transmission scheme (e.g., a codebook-based transmission scheme or a non-codebook-based transmission scheme). In a codebook-based transmission scheme, the NE 102 provides precoding matrix information to the UE 104, while in a non-codebook-based transmission scheme, the UE 104 determines the precoding matrix information (e.g., using reference signal feedback). The UE 104 can include one or more reference signals (e.g., demodulation reference signals (DMRSs)) with the PUSCH transmission 206 to provide for the NE 102 to estimate the channel (e.g., the PUSCH) and demodulate the data. The UE 104 can transmit the PUSCH transmission 206 to the NE 102.

In some examples, a duration of the PUSCH transmission 206 can range in numerical quantity of symbols in a slot (e.g., from 1 to 14 symbols in a slot). The UE 104 can support aggregation of multiple slots with TB repetition. Additionally, or alternatively, the UE 104 supports frequency hopping (e.g., intra-slot and inter-slot frequency hopping). For example, the UE 104 may support frequency hopping when slot aggregation is used.

The UE 104 can perform frequency hopping by changing one or more frequency resources used for a signal during transmission according to a frequency offset. The NE 102 can transmit signaling to the UE 104 via the downlink communication link 202 that indicates for the UE 104 to perform frequency hopping and/or that indicates the frequency offset. The frequency offset can include a numerical quantity of RBs, or another unit of frequency resources, that separates respective portions of a transmission. For intra-slot frequency hopping, the UE 104 can apply the frequency offset to portions of a transmission within a single slot. For example, a frequency hop may occur at a slot midpoint, dividing the slot into two frequency-domain resource allocations, such that the UE 104 transmits data symbols in the first half of the slot using a first frequency and data symbols in the second half of the slot using a second frequency that is the frequency offset from the first frequency. Intra-slot frequency hopping may provide frequency diversity within a short time frame (e.g., within the slot) and may improve performance for channels that fade relatively fast.

For inter-slot frequency hopping, the UE 104 can apply the frequency offset to a transmission between slots. For example, different slots of a PUSCH transmission 206 may be allocated different frequency resources. Inter-slot frequency hopping may provide frequency diversity over a longer time frame (e.g., across multiple slots), which may improve performance for channels that fade relatively slow or for transmissions that span multiple slots. The UE 104 and/or the NE 102 may implement frequency hopping to reduce performance impacts of frequency-selective fading, to improve system capacity, and to enhance interference diversity in multi-user scenarios. The NE 102 can transmit signaling that indicates a hopping pattern (e.g., including a frequency offset) and resources for the frequency hopping to the UE 104.

In some examples, the UE 104 and/or the NE 102 may apply codes or code sequences, such as OCCs or OCC sequences, to signaling to provide for multiple devices to transmit and/or receive concurrently on a same time-frequency resource without creating interference between the signaling. To apply the codes, the UE 104 and/or the NE 102 selects a code from a defined set of codes and use the code to multiply (e.g., repeat) data symbols or bits to spread a signal over a greater set of communication resources, which increases the resistance of the signal to interference and improves data security. In some cases, OCC sequences have zero cross-correlation when aligned (e.g., OCC sequences are orthogonal), such that multiple signals may be transmitted simultaneously without interfering with each other.

An OCC sequence may have a defined length. The length of an OCC sequence refers to the number of elements or chips in the OCC sequence. The length indicates a spreading factor and a number of orthogonal codes available in a set. For example, an OCC sequence with a length of 2 may be [1, 1] or [1, −1]. An OCC sequence with a length of 4 may be [1, 1, 1, 1], [1, −1, 1, −1], [1, 1, −1, −1], or [1, −1, −1, 1]. The length of the OCC sequence indicates a number of UEs 104 or data streams that can be multiplexed orthogonally, affects spreading gain and correspondingly, the potential coverage enhancement, and influences the resource utilization, as longer OCC sequences lead to increased time-frequency resources for spreading. The NE 102 may select an OCC sequence length to maximize a performance of the wireless communications system 200 related to multiplexing capacity, coverage, and resource efficiency. The NE 102 may transmit signaling to the UE 104 that indicates the OCC sequence length selected for the UE 104.

The UE 104 and/or the NE 102 may implement signal repetition to improve communication reliability and signal quality. For example, the UE 104 and/or the NE 102 may duplicate data bits, symbols, or entire data packets and send them consecutively or at different time intervals. However, the use of repetitions reduces the communication capacity of the wireless communications system 200 and throughput for individual devices (e.g., the UE 104 and/or the NE 102) by reducing the time-frequency resources available for communications. Further, the use of repetitions increases a transmission time for UEs 104, therefore increasing a use of uplink resources in the time domain before the uplink resources are released to other users. For NTNs, a coverage area of satellites is relatively large (e.g., greater than a threshold), and considering device density, greater than a threshold numerical quantity of UEs may be within the coverage area of the satellite. In some examples, such as for satellites in low earth orbit (LEO), a relatively large numerical quantity of UEs 104 in a coverage area of the satellites transmit data during a duration that the UEs 104 are within the coverage area of the satellite. Thus, the UEs 104 and the satellites may benefit from rapid access to, and release of time-frequency resources used by the satellite and the UEs 104. One or more UEs 104 may use a greater numerical quantity of time-frequency resources than other UEs 104 (e.g., depending on traffic patterns), thus the UEs 104 and the satellites may benefit from granularity of time-frequency resource multiplexing.

In some examples, to increase the communication capacity and/or throughput of the wireless communications system 200, the UE 104 and/or the NE 102 may multiplex signaling using OCC sequences. For example, the UE 104 and/or the NE 102 may apply the OCC sequences to the frequency resources or the time resources of a transmission. The UE 104 and/or the NE 102 may use OCC sequences for error detection and correction by adding redundancy to transmitted data. For example, the OCC sequences provide for a receiver (e.g., of the UE 104 and/or the NE 102) to detect and correct errors that may occur during transmission using the redundancy. Orthogonal codes (e.g., including the OCC sequences) are sequences that have zero cross-correlation with one another. That is, when two different orthogonal codes are compared, they do not interfere. Thus, multiple users can share a same set of frequency resources (e.g., a frequency band) by using different orthogonal codes. The UE 104 and/or the NE 102 can use the OCC sequences for spreading and despreading signals. When the UE 104 and/or the NE 102 transmit a data bit, the data bit is multiplied by a code (e.g., a spreading code, examples of which include the OCC sequence), which distributes the signal over a wider bandwidth. At the receiver, the signal is despread by multiplying the signal with the same code, which provides for the receiving device (e.g., the UE 104 and/or the NE 102) to distinguish the signal from noise and other signals. The OCC sequences enable the UE 104 and/or the NE 102 to multiplex multiple signals on a same channel. For example, because the orthogonal codes do not interfere with one another, multiple UEs 104 and/or NEs 102 can transmit data simultaneously on a same frequency band. Respective UEs 104 and/or NEs 102 are assigned a unique OCC sequence, which provides for the receiver to separate and recover individual signals.

However, the devices may not be provided with instructions that indicate how to apply the OCC sequences. For example, to increase the capacity and/or throughput of the wireless communications system 200, a UE 104 may apply the OCC sequences to frequency resources or time resources of an uplink transmission (e.g., a PUSCH transmission 206), but may not be configured with instructions to apply the OCC sequences to both the frequency resources and the time resources of the uplink transmission. Applying the OCC sequence to either frequency resources or time resources (e.g., and not both) may reduce a numerical quantity of UEs that are able to be multiplexed. Further, the uplink transmission may include a TB that is scheduled over multiple slots (e.g., TBoMS). However, the UE 104 may not be configured with instructions to apply the OCC sequences to the TB over the multiple slots. Applying the OCC sequences to the frequency resources or the time resources of the uplink transmission results in repetition of uplink data in the uplink transmission on same or to adjacent carrier frequencies. The repetition of the resources on the same or to the adjacent carrier frequencies may result in same, or similar, interference or fading conditions. Thus, the UE 104 may implement frequency hopping to the repeated resources to provide for improved reliability, frequency diversity gains, and interference mitigation. However, the UE 104 may not be configured with instructions to apply the OCC sequences to the uplink transmission when the UE 104 is also implementing frequency hopping.

In some examples, a NE can transmit signaling to a UE via the downlink communication link 202 that includes one or more parameters that indicate how the UE is to apply the OCC sequences to an uplink transmission (e.g., a PUSCH transmission 206). For example, the parameters can include one or more parameters for OCC sequence application 208. The signaling can include RRC signaling, a MAC-CE, and/or a DCI message that dynamically indicates the parameters for OCC sequence application 208. Additionally, or alternatively, the signaling can include RRC signaling that indicates a set of parameters for OCC sequence application 208, and a MAC-CE and/or DCI message that activates one or more parameters from the set of the parameters for OCC sequence application 208. In some cases, the UE 104 may apply an OCC sequence to frequency domain resources for an uplink transmission using a DFT-s-OFDM or CP-OFDM waveform. The NE 102 may transmit the parameters for OCC sequence application 208 to the UE 104 to synchronize the NE 102 and the UE 104 on different ways to apply the sequence to the uplink transmission for correct decoding of the uplink transmission at the NE 102.

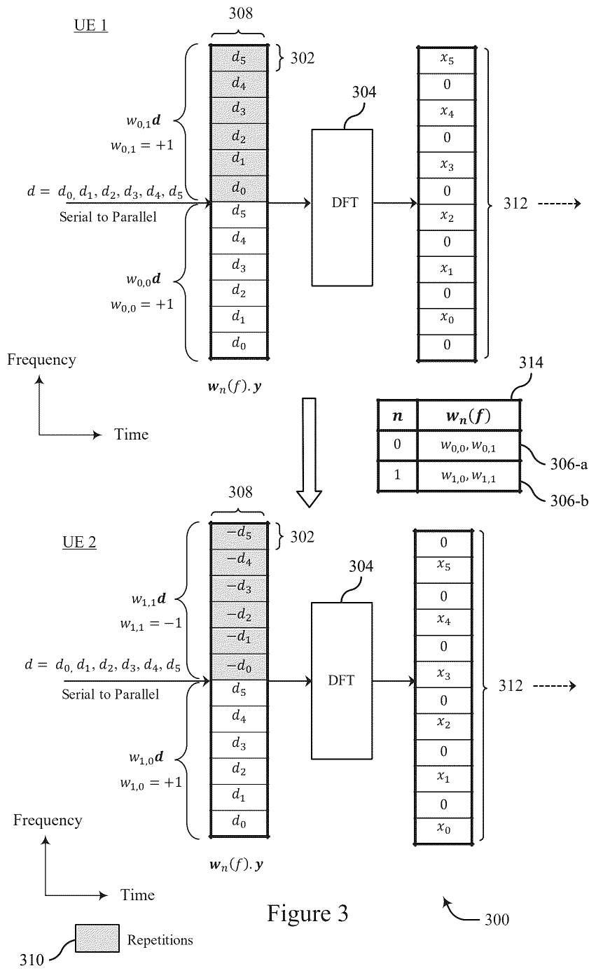

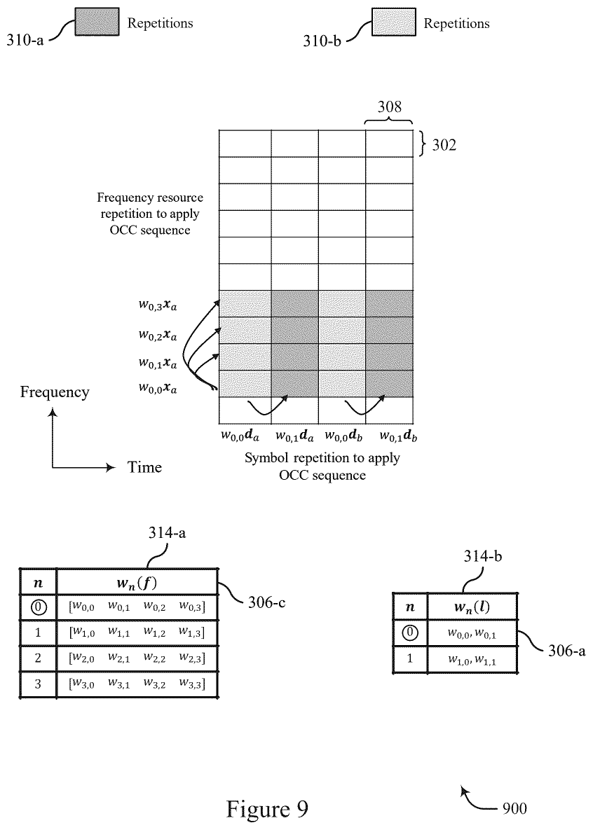

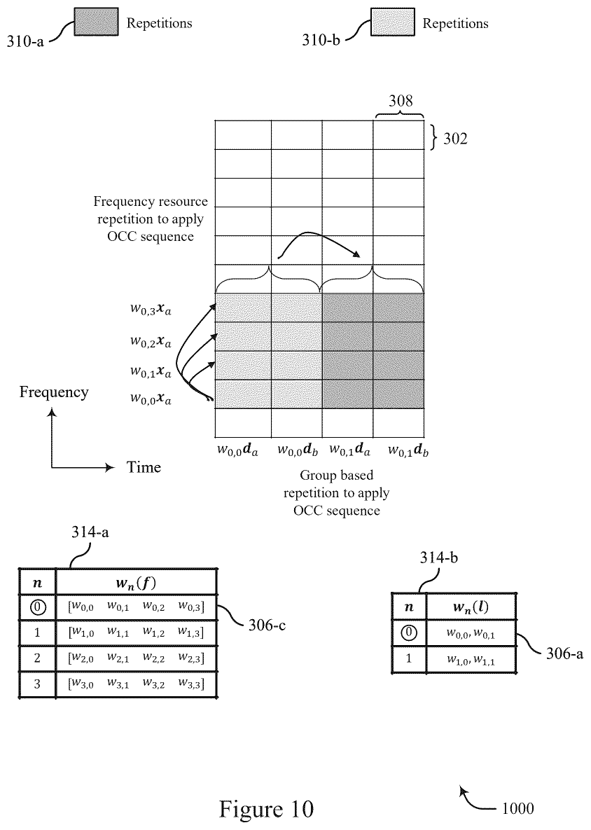

In some cases, the parameters for OCC sequence application 208 can indicate for the UE 104 to apply the OCC sequence within a slot (e.g., to individual symbols of a slot), which is referred to as intra-symbol OCC application. For example, at 210, the UE 104 may apply the OCC sequence to a PUSCH transmission 206 based on the parameters for OCC sequence application 208, such that uplink data and corresponding repetitions of the uplink data are repeated on frequency resources for respective symbols of the slot, which is described in further detail with respect to FIGS. 3 through 8. Additionally, or alternatively, the parameters may indicate for the UE 104 to apply the OCC sequence across a slot (e.g., to respective slots), which is referred to as intra-slot OCC application. For example, at 210, the UE 104 may apply the OCC sequence to a PUSCH transmission 206, such that uplink data and corresponding repetitions of the uplink data are repeated on time resources for respective symbols and/or slots, which is described in further detail with respect to FIGS. 9 and 10. The UE 104 can transmit the PUSCH transmission 206 on the time resources (e.g., the symbols and/or slots) and the frequency resources.

In some examples, the application of an OCC sequence depends on a length of the OCC sequence and the domain (e.g., time domain or frequency domain) in which the OCC sequence is applied. For time domain application (e.g., inter-symbol or inter-slot OCC application), data symbols are repeated to match the OCC sequence length. Respective repeated symbols are multiplied by the corresponding element (e.g., codeword) of the OCC sequence. For example, with an OCC sequence with a length of 4, [1, −1, 1, −1], and data symbol, d, a resulting sequence would be [d, −d, d, −d]. For frequency-domain application (e.g., intra-symbol OCC application) a data symbol is repeated across multiple subcarriers (e.g., REs), with a number of repetitions equal to the OCC sequence length. Respective repeated instances are multiplied by the corresponding OCC sequence element (e.g., codeword). For example, with an OCC sequence with a length of 4, [1, 1, −1, −1], and data symbol, d, the resulting allocation across four subcarriers would be [d, d, −d, −d]. For multi-dimensional application (e.g., both time and frequency domains), data is repeated in both domains to match one or more OCC sequence lengths. The OCC sequences are applied across the repeated data in a specified pattern.

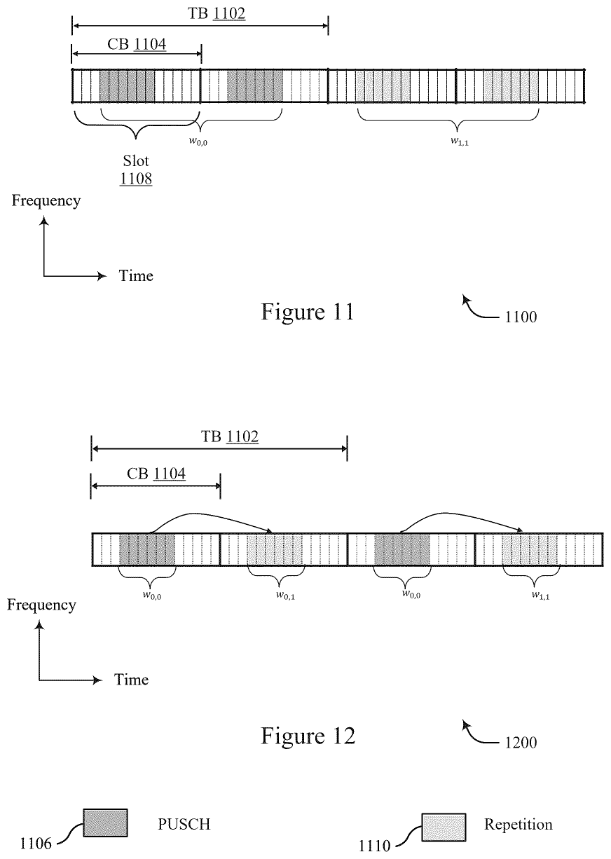

In some examples, the NE 102 may transmit signaling to the UE 104 via the downlink communication link 202 that schedules a PUSCH transmission 206 that includes a TB over multiple slots (e.g., a TBoMS transmission). The parameters for OCC sequence application 208 can indicate for the UE 104 to apply the OCC sequence to the PUSCH transmission 206 within respective slots, across the respective slots, or both. Additionally, or alternatively, the parameters may indicate for the UE 104 to apply the OCC sequence to CB segments of the TB or to the entire TB, which is described in further detail with respect to FIGS. 11 and 12.

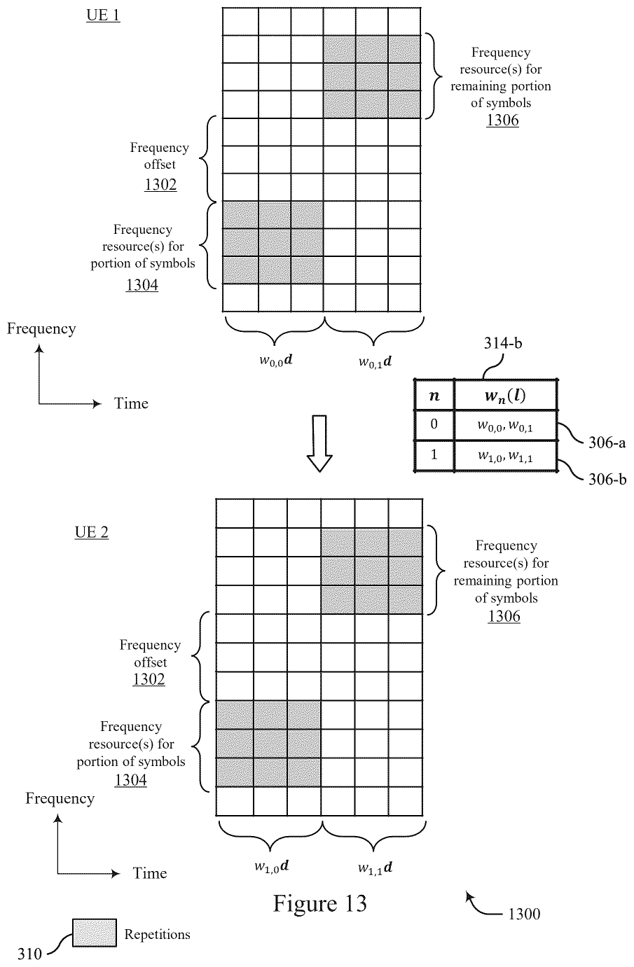

In some examples, the NE 102 can transmit signaling to the UE 104 via the downlink communication link 202 that indicates for the UE 104 to perform frequency hopping according to a frequency offset (e.g., a numerical quantity of frequency resources, including RBs). The parameters may indicate for the UE 104 to apply the OCC sequence to repetitions in a PUSCH transmission 206 that are separated by the frequency offset. For example, the UE 104 may apply one or more OCC sequences within respective slots, across the slots, or both for frequency hopping within the slot or across multiple slots, which is described in further detail with respect to FIGS. 13 through 18.

FIG. 3 illustrates an example of a resource diagram 300 in accordance with aspects of the present disclosure. In some examples, the resource diagram 300 may implement aspects of the wireless communications system 100 and the wireless communications system 200. The resource diagram 300 may be implemented by a UE 1 and/or a UE 2 for intra-symbol OCC application for one or more REs 302 before applying a DFT 304, where the UE 1 and the UE 2 may be examples of UEs 104 as described with reference to FIGS. 1 and 2.

In some cases, a UE (e.g., the UE 1 and/or the UE 2) may apply one or more OCC sequences (e.g., an OCC sequence 306-a and an OCC sequence 306-b, respectively) to frequency resources of a symbol 308 while using an OFDM waveform or DFT-s-OFDM waveform. The frequency resources can include resources in the frequency domain, such as one or more RBs and/or REs 302. To apply an OCC sequence to the frequency resources, the UE may repeat data in the frequency domain, where the UE may use different types of repetition. For a DFT-s-OFDM waveform, intra-symbol OCC application (e.g., applying an OCC sequence at a symbol 308) may occur prior to (e.g., before) application of a DFT 304 or after the application of the DFT 304, generating different types of data signal patterns and OCC application patterns. In some examples, a NE (e.g., a NE 102, as described with reference to FIGS. 1 and 2) may transmit signaling to the UE that configures parameters for applying an OCC sequence to a symbol 308 of an uplink data transmission.

In some examples, when an OCC sequence is to be applied to the frequency domain resources of a PUSCH transmission (e.g., a PUSCH transmission 206, as described with reference to FIG. 2) with transform precoding enabled, a NE may use different methods to apply the OCC sequence. The NE can transmit signaling to one or more UEs that includes an indication, which can include an explicit or implicit indication, of how the UEs are to apply OCC sequences to a PUSCH transmission (e.g., including uplink data) in the frequency domain. In some cases, the signaling may be dedicated dynamic signaling using a DCI message, a MAC-CE, or higher layer signaling (e.g., RRC signaling). The signaling may include a configuration to indicate the frequency domain OCC sequence application, the configuration including a set of parameters. Example parameters include, but are not limited to, a parameter indicating whether intra-symbol OCC application (e.g., in the frequency domain) is enabled or disabled, a parameter indicating an intra-symbol OCC method type (e.g., pre-DFT, post-DFT or frequency domain-based), a parameter indicating an intra-symbol repetition type (e.g., RE-based or RB-based), one or more characteristics of the OCC sequence (length, index, etc.), a frequency domain resource allocation (e.g., number of RBs and/or REs 302 for data).

The signaling may be group-based signaling and can indicate a portion or all of the parameters for the intra-symbol OCC application. For example, the signaling may include a parameter that indicates an identifier of a group of UEs. The grouping of the UEs may be based on criteria set by a NE, where the criteria can include a signal quality threshold value, including RSRP or RSRQ, or a distance from a reference point, among other examples. In some examples, such as if the signaling is RRC signaling, the NE may use either a dedicated IE for the indication of the OCC sequence related parameters or the OCC sequence related parameters may be part of resource allocation signaling (e.g., a configured grant IE). In some cases, when intra-symbol OCC application is enabled and resources for a PUSCH transmission are allocated over multiple symbols 308 in a slot or on multiple slots in the time domain, the same intra-symbol OCC application procedure may be applied across the allocated symbols 308 in a slot or on multiple slots that are configured for the PUSCH transmission. In some cases, the NE may indicate for the UE to change the intra-symbol OCC application procedure to a new configuration (e.g., through a DCI message or RRC signaling), and the UE may start the next PUSCH transmission using the new configuration.

In some examples, such as in the resource diagram 300, a UE 1 may apply an OCC sequence 306-a to symbols in the time domain before application of transform precoding (e.g., before application of a DFT matrix) and after the symbols are arranged from serial to parallel, where the application of the OCC sequence 306-a is RE-based. For example, the UE 1 and the UE 2 can arrange one or more symbols (e.g., d₀ through d₅) in parallel and can apply the OCC sequence 306-a and the OCC sequence 306-b, respectively to the REs 302 in the symbol 308. The UE 1 and the UE 2 may repeat uplink data within respective RB lengths, where the repetition is up to a length of the OCC sequence 306-a and the OCC sequence 306-b, respectively. Thus, a length of the uplink data may be equal to a numerical quantity of REs 302 assigned to a UE divided by an assigned length of an OCC sequence (e.g., indicated by signaling from the NE). If same frequency resources of an RB length are assigned to two UEs (e.g., the UE 1 and the UE 2) along with an OCC sequence with a length of two, the length of data symbols would be half of the RB length. The UE 1 and the UE 2 repeat the data symbols as a group to the consecutive REs 302 (e.g., repetitions 310).

The UE 1 and the UE 2 can apply a DFT 304 to the repeated data symbols. The output of the DFT 304 includes a sequence of numbers 312 that include a frequency domain representation of an input time domain signal. In some examples, the UE 1 and the UE 2 may determine to use the OCC sequence 306-a and the OCC sequence 306-b, respectively, based on a look up table 314. For example, the NE can transmit signaling (e.g., the signaling configuring the intra-symbol OCC application) that includes a parameter indicating an index of the OCC sequence 306-a and the OCC sequence 306-b in the look up table 314.

In some examples, a NE may transmit signaling to one or more UEs (e.g., the UE 1 and the UE 2) that configures multiple look up tables 314 for OCC sequences. For example, the NE transmits RRC signaling, or other higher layer signaling, that indicates the look up tables 314. The signaling can include, but is not limited to, one or more parameters indicating a size of the look up table 314 (e.g., a number of available OCC sequences in the look up table 314), a length of respective OCC sequences in the look up table 314, the OCC sequences themselves, or a reference to a defined set of OCC sequences. In some examples, a look up table 314 may include OCC sequences of same lengths, such that a first look up table 314 includes OCC sequences of a first length (e.g., 2) and a second look up table 314 includes OCC sequences of a second length (e.g., 4). In some other examples, a look up table 314 may include OCC sequences of different lengths, such that a first OCC sequence in a look up table 314 has a first length (e.g., 2) and a second OCC sequence in the look up table 314 has a second length (e.g., 4). In some examples, the OCC sequences may be organized in the look up table 314 according to an index. Thus, a UE and/or a NE may identify an OCC sequence in the look up table 314 according to an index of the OCC sequence. The look up table 314 may additionally, or alternatively, be referred to as a table, a list, or any other indexed group of OCC sequences.

In some examples, the UEs (e.g., the UE 1 and the UE 2) store one or more look up tables 314 in memory. For transmissions subsequent to the signaling that configures the look up tables 314, the NE indicates which OCC sequence to use by sending an index value referencing the configured look up table (e.g., via dynamic control signaling, including DCI and/or a MAC-CE). The UEs retrieve the OCC sequences from stored look up tables 314 using respective indices, which provides for flexible configuration of OCC sequences while minimizing the signaling overhead for uplink transmissions.

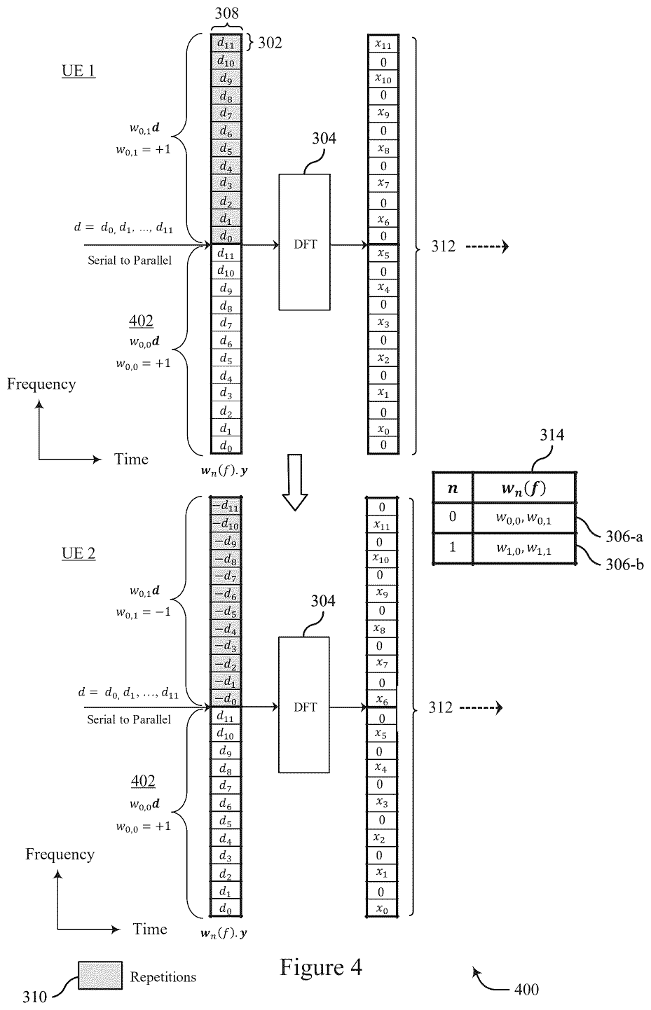

FIG. 4 illustrates an example of a resource diagram 400 in accordance with aspects of the present disclosure. In some examples, the resource diagram 400 may implement aspects of the wireless communications system 100, the wireless communications system 200, and the resource diagram 300. For example, the resource diagram 400 may include REs 302, a DFT 304, an OCC sequence 306-a, an OCC sequence 306-b, and a symbol 308, repetitions 310, sequence of numbers 312, and a look up table 314, as described with reference to FIG. 3. The resource diagram 400 may be implemented by a UE 1 and/or a UE 2 for intra-symbol OCC application for one or more RBs 402 before applying a DFT 304, where the UE 1 and the UE 2 may be examples of UEs 104 as described with reference to FIGS. 1 and 2.

In some examples, such as in the resource diagram 400, a UE 1 may apply an OCC sequence 306-a to symbols in the time domain before application of transform precoding (e.g., before application of a DFT matrix) and after the symbols are arranged from serial to parallel, where the application of the OCC sequence 306-a is RB-based. For example, the UE 1 and the UE 2 can arrange one or more symbols (e.g., d₀ through d₅) in parallel and can apply the OCC sequence 306-a and the OCC sequence 306-b, respectively to the RBs 402 in the symbol 308. For example, the UE 1 can apply one of the elements of the OCC sequence 306-a at least to one of the assigned RB length symbols 308, depending on the assigned RBs 402 and a length of the OCC sequence 306-a. Additionally, or alternatively, the UE 2 can apply one of the elements of the OCC sequence 306-b at least to one of the assigned RB length symbols 308, depending on the assigned RBs 402 and a length of the OCC sequence 306-b. Thus, the data is repeated to the length of OCC sequence 306-a and the OCC sequence 306-b, respectively. The UE 1 and the UE 2 apply the OCC sequence 306-a and the OCC sequence 306-b, respectively, to the uplink symbols and to the repeated symbols (e.g., the repetitions 310) in the time domain.

For example, if a UE is assigned 4 RBs 402 and a length of an OCC sequence is 2, then the UE maps the uplink data corresponding to 2 RBs 402 and then repeats the 2 RBs. The UE applies a first codeword of the OCC sequence to the first 2 RB length symbols and a second codeword of the OCC sequence to the next 2 RB length symbols arranged in serial to parallel. Similarly, if a UE is assigned with 4 RBs and a length of an OCC sequence is 4, then the UE maps the uplink data corresponding to one RB and then repeats the data corresponding to 3 RBs. The UE applies a first codeword of the OCC sequence to a first RB length and subsequently applies remaining codewords of the OCC sequence to the remaining RB length repeated symbols. FIG. 4 illustrates an example of a length of an OCC sequence of 2 with 2 RBs.

The UE 1 and the UE 2 can apply a DFT 304 to the repeated data symbols. The output of the DFT 304 includes a sequence of numbers 312 that include a frequency domain representation of an input time domain signal. In some examples, the UE 1 and the UE 2 may determine to use the OCC sequence 306-a and the OCC sequence 306-b, respectively, based on a look up table 314. For example, the NE can transmit signaling (e.g., the signaling configuring the intra-symbol OCC application) that includes a parameter indicating an index of the OCC sequence 306-a and the OCC sequence 306-b in the look up table 314.

In some examples, a NE may explicitly configure the UE to apply the OCC sequence prior to applying a DFT 304 via a dedicated field and along with the other OCC application parameters. For example, the NE may transmit a DCI message or a MAC-CE to dynamically configure the UE to apply the OCC sequence prior to applying the DFT and/or may transmit higher layer signaling to configure the UE to apply the OCC sequence prior to applying the DFT (e.g., as part of a PUSCH configuration or in configured grant based resource allocation). Additionally, or alternatively, the NE may configure the UE to perform RE-based repetitions or RB-based (e.g., at least an RB length) repetitions.

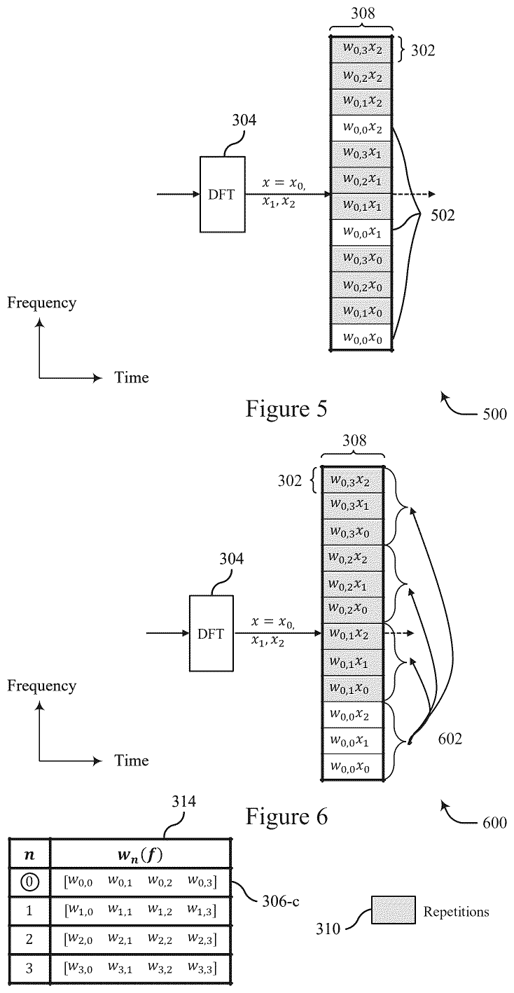

FIG. 5 illustrates an example of a resource diagram 500 in accordance with aspects of the present disclosure. In some examples, the resource diagram 500 may implement aspects of the wireless communications system 100, the wireless communications system 200, the resource diagram 300, and the resource diagram 400. For example, the resource diagram 500 may include REs 302, a DFT 304, an OCC sequence 306-c, a symbol 308, repetitions 310, and a look up table 314, as described with reference to FIG. 3. The resource diagram 500 may illustrate an example of a repetition pattern (e.g., repetition type 1) for a RE-based PUSCH transmission. The resource diagram 500 may be implemented by a UE, where the UE may be an example of a UE 104 as described with reference to FIGS. 1 and 2.

In some examples, a UE may repeat uplink data symbols to a length of an OCC sequence 306-c in the frequency domain after applying a DFT 304. The UE may apply one or more OCC sequences to one or more frequency domain data samples 502 in uplink data. In some cases, the UE may apply different types of repetitions (e.g., repetition patterns) to the PUSCH transmission in the frequency domain. For example, the UE may apply a repetition type 1 or a repetition type 2 to the PUSCH transmission. In some cases, a NE may transmit signaling to the UE that indicates a repetition pattern or repetition type, for the UE to use. For example, the NE can transmit a DCI message, a MAC-CE, and/or RRC signaling that indicates the repetition type 1 or the repetition type 2. In some examples, the repetition of the data in the frequency domain may be within an RB. Thus, the data may be repeated on the REs 302 of the RB according to the length of the OCC sequence (e.g., 4 for the OCC sequence 306-c). For example, if a UE is configured with an OCC sequence with a length of 2 and is performing intra-symbol OCC application (e.g., repetitions 310 are in the frequency domain), the UE may use half of the REs 302 of an RB for the repetitions 310 of same data (e.g., the frequency domain data samples 502) to apply the OCC sequence.

In some examples, the UE may determine to use the OCC sequence 306-c based on a look up table 314. For example, a NE can transmit signaling (e.g., the signaling configuring the intra-symbol OCC application) that includes a parameter indicating an index of the OCC sequence 306-c in the look up table 314. In some examples, the NE may explicitly configure the UE to apply the OCC sequence 306-c after applying a DFT 304 via a dedicated field and along with the other OCC application parameters. For example, the NE may transmit a DCI message or a MAC-CE to dynamically configure the UE to apply the OCC sequence after applying the DFT 304 and/or may transmit higher layer signaling to configure the UE to apply the OCC sequence after applying the DFT 304 (e.g., as part of a PUSCH configuration or in configured grant based resource allocation).

The repetition of the frequency domain data samples 502 in an RB (e.g., for RE-based repetition) may be defined by two different repetition patterns, including the repetition type 1 and the repetition type 2. The pattern type may be indicated to the UE by the NE (e.g., through DCI, MAC-CE, or RRC signaling). The signaling may ensure different UEs use a defined frequency pattern for intra-symbol OCC application for correct decoding at a receiver. In a first type of pattern (e.g., PUSCH frequency domain repetition type 1), the frequency domain data samples 502 are first repeated to the next REs 302 up to the length of the OCC sequence, and then the OCC sequence is applied, as shown in FIG. 5. For example, if a length of the OCC sequence is 4, a data symbol of the frequency domain data samples 502 is repeated three times consecutively, as shown in FIG. 5.

FIG. 6 illustrates an example of a resource diagram 600 in accordance with aspects of the present disclosure. In some examples, the resource diagram 600 may implement aspects of the wireless communications system 100, the wireless communications system 200, and the resource diagram 300 through the resource diagram 500. For example, the resource diagram 600 may include REs 302, a DFT 304, an OCC sequence 306-c, a symbol 308, repetitions 310, and a look up table 314, as described with reference to FIG. 3. The resource diagram 600 may illustrate an example of a repetition pattern (e.g., repetition type 2) for a RE-based PUSCH transmission. The resource diagram 600 may be implemented by a UE, where the UE may be an example of a UE 104 as described with reference to FIGS. 1 and 2.

In some examples, a UE may repeat uplink data symbols to a length of an OCC sequence 306-c in the frequency domain after applying a DFT 304, as described with reference to FIG. 5. For example, the UE may apply one or more OCC sequences to one or more frequency domain data samples 602 in uplink data. The UE may determine to apply the OCC sequence 306-c based on a look up table 314. For example, a NE can transmit signaling (e.g., the signaling configuring the intra-symbol OCC application) that includes a parameter indicating an index of the OCC sequence 306-c in the look up table 314. In some examples, the NE may explicitly configure the UE to apply the OCC sequence 306-c after applying a DFT 304 via a dedicated field and along with the other OCC application parameters. For example, the NE may transmit a DCI message or a MAC-CE to dynamically configure the UE to apply the OCC sequence after applying the DFT 304 and/or may transmit higher layer signaling to configure the UE to apply the OCC sequence after applying the DFT 304 (e.g., as part of a PUSCH configuration or in configured grant based resource allocation).

The repetition of the frequency domain data samples 602 in an RB (e.g., for RE-based repetition) may be defined by two different repetition patterns, including a repetition type 1 and the repetition type 2. The pattern type may be indicated to the UE by the NE (e.g., through DCI, MAC-CE, or RRC signaling). The signaling may ensure different UEs use a defined frequency pattern for intra-symbol OCC application for correct decoding at a receiver. In a second type of repetition pattern (e.g., PUSCH frequency domain repetition type 2), a UE maps the frequency domain data samples 602 corresponding to an RB to the consecutive REs 302 and then the one or more frequency domain data samples 602 is repeated. After the repetitions 310, the UE applies the OCC sequence 306-c to the repeated symbols. Thus, the UE applies the data symbols within an RB to consecutive REs 302 and then repeats the data symbols to the next REs 302 as a group, as shown in FIG. 6.

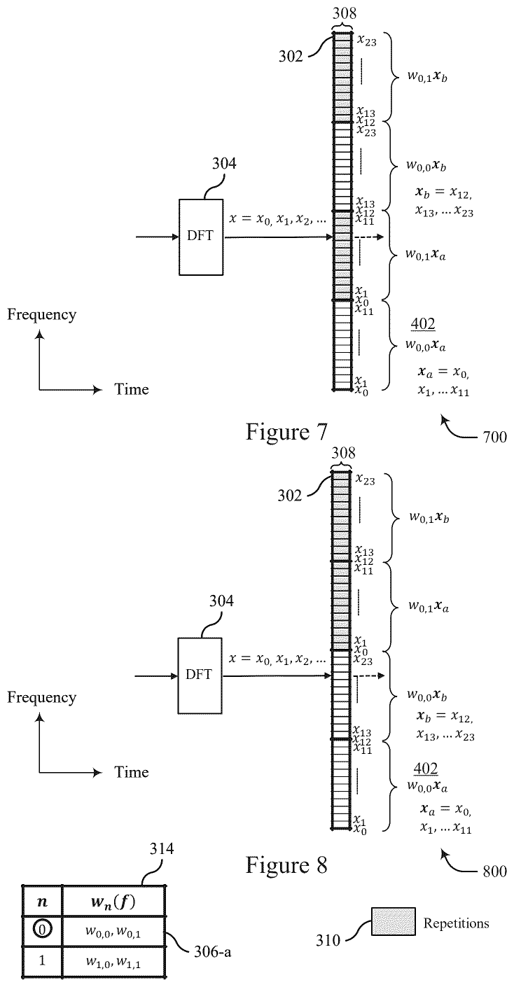

FIG. 7 illustrates an example of a resource diagram 700 in accordance with aspects of the present disclosure. In some examples, the resource diagram 700 may implement aspects of the wireless communications system 100, the wireless communications system 200, and the resource diagram 300 through the resource diagram 600. For example, the resource diagram 700 may include REs 302, a DFT 304, an OCC sequence 306-a, a symbol 308, repetitions 310, and a look up table 314, as described with reference to FIG. 3. The resource diagram 700 may illustrate an example of a repetition pattern (e.g., repetition type 1) for an RB-based PUSCH transmission. The resource diagram 700 may be implemented by a UE, where the UE may be an example of a UE 104 as described with reference to FIGS. 1 and 2.

In some examples, a UE may apply an OCC sequence across RBs 402 after applying a DFT 304. For example, repetitions 310 are based on RBs 402 and the UE applies the OCC sequence 306-a to RBs 402 (e.g., rather than on REs, as described with reference to FIGS. 5 and 6). The UE may apply one or more OCC sequences to one or more RBs 402 that include uplink data. The UE may determine to apply the OCC sequence 306-a based on a look up table 314. For example, a NE can transmit signaling (e.g., the signaling configuring the intra-symbol OCC application) that includes a parameter indicating an index of the OCC sequence 306-a in the look up table 314. In some examples, the NE may explicitly configure the UE to apply the OCC sequence 306-a after applying a DFT 304 via a dedicated field and along with the other OCC application parameters. For example, the NE may transmit a DCI message or a MAC-CE to dynamically configure the UE to apply the OCC sequence after applying the DFT 304 and/or may transmit higher layer signaling to configure the UE to apply the OCC sequence after applying the DFT 304 (e.g., as part of a PUSCH configuration or in configured grant based resource allocation).

The repetition of the RBs 402 (e.g., for RB-based repetition) may be defined by two different repetition patterns, including the repetition type 1 and a repetition type 2. The pattern type may be indicated to the UE by the NE (e.g., through DCI, MAC-CE, or RRC signaling). The signaling may ensure different UEs use a defined frequency pattern for intra-symbol OCC application for correct decoding at a receiver. If the UE is using repetitions type 1 for RB-based OCC application, as illustrated in FIG. 7, then the UE maps the symbols after the DFT 304 to the REs 302 of an RB 402. The UE repeats an entire RB to a length of an OCC sequence 306-a (e.g., 2).

FIG. 8 illustrates an example of a resource diagram 800 in accordance with aspects of the present disclosure. In some examples, the resource diagram 800 may implement aspects of the wireless communications system 100, the wireless communications system 200, and the resource diagram 300 through the resource diagram 700. For example, the resource diagram 800 may include REs 302, a DFT 304, an OCC sequence 306-a, a symbol 308, repetitions 310, and a look up table 314, as described with reference to FIG. 3. The resource diagram 800 may illustrate an example of a repetition pattern (e.g., repetition type 2) for an RB-based PUSCH transmission. The resource diagram 800 may be implemented by a UE, where the UE may be an example of a UE 104 as described with reference to FIGS. 1 and 2.

In some examples, a UE may apply an OCC sequence across RBs 402 after applying a DFT 304. For example, repetitions 310 are based on RBs 402 and the UE applies the OCC sequence 306-a to RBs 402 (e.g., rather than on REs, as described with reference to FIGS. 5 and 6). The UE may apply one or more OCC sequences to one or more RBs 402 that include uplink data. The UE may determine to apply the OCC sequence 306-a based on a look up table 314. For example, a NE can transmit signaling (e.g., the signaling configuring the intra-symbol OCC application) that includes a parameter indicating an index of the OCC sequence 306-a in the look up table 314. In some examples, the NE may explicitly configure the UE to apply the OCC sequence 306-a after applying a DFT 304 via a dedicated field and along with the other OCC application parameters. For example, the NE may transmit a DCI message or a MAC-CE to dynamically configure the UE to apply the OCC sequence after applying the DFT 304 and/or may transmit higher layer signaling to configure the UE to apply the OCC sequence after applying the DFT 304 (e.g., as part of a PUSCH configuration or in configured grant based resource allocation).

The repetition of the RBs 402 (e.g., for RB-based repetition) may be defined by two different repetition patterns, including the repetition type 1 and a repetition type 2. The pattern type may be indicated to the UE by the NE (e.g., through DCI, MAC-CE, or RRC signaling). The signaling may ensure different UEs use a defined frequency pattern for intra-symbol OCC application for correct decoding at a receiver. If the UE is using frequency domain repetition type 2 for RB-based OCC application, then after applying the DFT 304, the UE maps symbols to the REs 302 of consecutive RBs 402. The UE maps the consecutive RBs 402 to the data samples in a symbol and repeats the data samples as a group to the length of the OCC sequence 306-a (e.g., 2), as shown in FIG. 8.

In some cases, the NE may use a combination of repetition methods to apply an OCC sequence. The NE may transmit an indication to a group of UEs to use one of the repetition methods to apply an OCC sequence. For example, the NE may indicate for a group of UEs to implement RB-based repetition to apply an OCC sequence and may indicate for another group of UEs to use RE-based repetition to apply the OCC sequence. The NE may select the group of UEs (e.g., selection criteria for choice of method may be based on frequency domain resources for a set of UEs).

In some cases, the NE may also use a combination of methods to apply the OCC sequence, where the methods include pre-DFT OCC application, as described with reference to FIGS. 3 and 4, and post-DFT OCC application, as described with reference to FIGS. 5 through 8. For example, the NE may indicate for a group (e.g., set) of UEs to perform pre-DFT OCC application and another group of UEs to perform post-DFT OCC application. The NE may include signaling that indicates the method to apply the OCC sequence (e.g., pre-DFT, post-DFT, in the frequency domain, and/or in the time domain) either in dedicated signaling or in group common signaling.

If a NE schedules a PUSCH transmission dynamically (e.g., by a DCI message, by a random access response (RAR) uplink grant, or a configured grant), transform precoding is enabled, and intra-symbol OCC application is enabled (e.g., for frequency domain application), then the UE may calculate a TBS based on an implicit or an explicit indication of a set of parameters from the NE. In some cases, the UE implicitly incorporates a length of the OCC sequence while calculating a numerical quantity of REs 302 within a physical RB (PRB) for a slot for the purpose of transport block size (TBS) calculation for a PUSCH transmission (e.g., for RE-based intra-symbol OCC application). For example, if an OCC sequence is configured for intra-symbol OCC application, then the UE determines a numerical quantity (e.g., number, amount) of REs 302 allocation per RB 402 available for a PUSCH transmission within a PRB

$$( {N}_{RE}^{′} )$$

using this implicit indication by

$${N}_{RE}^{′} = ( {N}_{sc}^{RB} \cdot {N}_{symb}^{sh} - {N}_{DMRS}^{PRB} - {N}_{oh}^{PRB} ) / {N}_{L}^{FD - OCC} ,$$

where

$${N}_{sc}^{RB} = 12$$

is a number of subcarriers in the frequency domain in a physical resource block,

$${N}_{symb}^{sh}$$

is the number of time domain symbols L of the PUSCH allocation for scheduled PUSCH,

$${N}_{DMRS}^{PRB}$$

is the number of REs 302 for a DMRS per PRB in the allocated duration including the overhead of the DMRS code division multiplexing (CDM) groups without data,

$${N}_{oh}^{PRB}$$

is the overhead if configured by a higher layer parameter, and

$${N}_{L}^{FD - OCC}$$

is a length of the configured OCC sequence for intra-symbol OCC application. If intra-symbol OCC application is not enabled, then by default, the UE may use a value of

$${N}_{L}^{FD - OCC} = 1.$$

Once the UE calculates the

$${N}_{RE}^{′}$$

value, the UE may determine a total number of REs 302 allocated for a PUSCH transmission, (N_{RE}), with an OCC sequence using

$${N}_{RE} = min ( 1 \; 56 , {N}_{RE}^{′} ) \cdot {n}_{PRB} ,$$

where n_{PRB} is a total number of allocated PRBs for the UE (e.g., indicated to the UE in a PUSCH resource allocation configuration dynamically by DCI or through RRC signalling using configured grant IEs).

Additionally, or alternatively, the UE may implicitly incorporate a length of an OCC sequence while determining a total number of REs 302 allocated for a PUSCH transmission for TBS calculation. For example, if an OCC sequence is configured for intra-symbol OCC application using an RB-based implementation, then the UE may implicitly incorporate the length of the OCC sequence. The UE may determine the number of REs 302 allocation per RB 402 available for the purpose of TBS calculation for a PUSCH transmission within a

$$PRB = ( {N}_{RE}^{′} ) by {N}_{RE}^{′} = {N}_{sc}^{RB} .$$

$${N}_{symb}^{sh} - {N}_{DMRS}^{PRB} - {N}_{oh}^{PRB} .$$

### Once the

$${N}_{RE}^{′}$$

value is calculated, the UE may determine the total number of REs 302 allocated for the PUSCH transmission, (N_{RE}), with the utilization of a length of the OCC sequence. For example, if TB processing over multiple slots is configured by the NE, then the UE may use

$${N}_{RE} = N * min ( 1 \; 56 , {N}_{RE}^{′} ) \cdot {n}_{PRB} / {N}_{L}^{FD - OCC} ,$$

where N is the number of slots used for TBS determination that may be indicated dynamically or by RRC signaling (e.g., using numberOfSlotsTBoMS), and

$${N}_{L}^{FD - OCC}$$

is a length of the configured OCC sequence for intra-symbol OCC application. If OCC is not enabled, then the UE may use a default value of

$${N}_{L}^{FD - OCC} = 1.$$

In some other cases, the UE may calculate a total number of REs 302 allocated for a PUSCH transmission using

$${N}_{RE} = min ( 156 , {N}_{RE}^{′} ) \cdot {n}_{PEB} / {N}_{L}^{FD - OCC} .$$

In some examples, the NE may transmit an explicit indication of a parameter for the UE to use for the calculation of TBS to correctly determine the number of actual information bits for the UE to use without repetition in a symbol, a slot, or on multiple slots.

FIG. 9 illustrates an example of a resource diagram 900 in accordance with aspects of the present disclosure. In some examples, the resource diagram 900 may implement aspects of the wireless communications system 100, the wireless communications system 200, and the resource diagram 300 through the resource diagram 800. For example, the resource diagram 900 may include REs 302, an OCC sequence 306-a, an OCC sequence 306-b, a symbol 308, repetitions 310-a, repetitions 310-b, a look up table 314-a, and a look up table 314-b, as described with reference to FIG. 3. The resource diagram 900 may illustrate an example of combining intra-symbol OCC application and intra-slot OCC application using symbol-wise repetition. The resource diagram 900 may be implemented by a UE, where the UE may be an example of a UE 104 as described with reference to FIGS. 1 and 2.

The application of OCC to either time resources or frequency resources may reduce a number of UEs that can be multiplexed, as multiplexing a higher number of UEs in either time or frequency using intra-slot (e.g., inter-symbol) OCC application or intra-symbol OCC application may result in higher resource allocation. Thus, a UE may combine intra-slot OCC application with intra-symbol OCC application and to enhance the number of UEs to be multiplexed and to increase capacity and/or throughput. For example, a UE may implement intra-symbol OCC application and inter-symbol OCC application for uplink data transmission (e.g., PUSCH transmission) simultaneously.

A NE may transmit signaling to a UE that indicates for the UE to apply an OCC sequence in a frequency domain by repeating frequency resources (e.g., RBs and/or REs 302) to a length of an OCC sequence and to apply another OCC sequence in the time domain by repeating time resources (e.g., symbols or slots). The repetition in the time domain may be either symbol-based or slot-based. For example, if the UE is configured with intra-symbol OCC application and with inter-symbol (e.g., intra-slot) OCC application, then the UE applies an OCC sequence 306-c from the look up table 314-a in the frequency domain and an OCC sequence 306-a from the look up table 314-b in the time domain (e.g., to symbols 308 in the time domain). That is, the UE repeats the frequency resources according to a length of the OCC sequence 306-c and repeats the symbols 308 according to a length of the OCC sequence 306-a (e.g., repeating the time resources in a slot). The repetitions 310-a and the repetitions 310-b are a result of applying the OCC sequences (e.g., the OCC sequence 306-c and the OCC sequence 306-a).

If a UE is configured to perform intra-symbol OCC application and with inter-symbol (e.g., intra-slot) OCC application, then the UE may apply the OCC sequence not only in the frequency domain, but also to symbols in the time domain. In some cases, the UE may apply the OCC sequence in the time domain based on sub-slots. That is, for inter-symbol OCC application, a UE applies an OCC sequence time domain data symbols, where repetition for the purpose of inter-symbol OCC application occurs across sub-slots, such that the data symbols are repeated in sub-slots. In some cases, if a UE is configured to apply the OCC sequence 306-c for intra-symbol OCC application and the OCC sequence 306-a for inter-slot OCC application, then the UE repeats the frequency resources according to a length of the OCC sequence 306-c (e.g., 4) and repeats the time resources (e.g., an entire slot for slot-based repetitions) according to a length of the OCC sequence 306-a (e.g., 2), such that OCC sequences are applied to the frequency resources and to the repeated slots.

In some examples, a UE receives signaling from a NE including a configuration for enabling both types of OCC application. The configuration can include, but is not limited to, a parameter enabling the two types of OCC application (e.g., intra-symbol OCC application enabled and intra-slot OCC application enabled), one or more parameters indicating respective lengths of the two OCC sequences (e.g., separate fields for both types of OCC application), two indices corresponding to selection of respective OCC sequences from the look up table for the enabled types of OCC application (e.g., an index of the OCC sequence 306-c in the look up table 314-a for intra-symbol OCC application and an index of the OCC sequence 306-a in the look up table 314-b for intra-slot OCC application), a repetition pattern common for both types of OCC application (e.g., group-based or repetition per symbol 308, RE 302, and/or RB), or separate repetition patterns for respective enabled types of OCC application, among others.

In some cases, a UE may receive a configuration with both types of OCC application enabled, a single length of an OCC sequence (e.g., for selection of an OCC sequence from a look up table from a set of predefined look up tables of various lengths), and an index (e.g., for selection of OCC sequence from the look up table). The UE may apply a same index from a same length table for both enabled types of OCC application. In some other cases, A NE may specify different look up tables for intra-symbol OCC application and intra-slot OCC application (e.g., time domain and frequency domain OCC types). The NE may transmit signaling to the UE that indicates a single length of an OCC sequence and a same or different index, and the UE may select a corresponding look up table for respective enabled types of OCC application, where the length of the OCC sequences is the same. However, the OCC sequence may be the same or different based on the received signaling. In some cases, if a UE is configured with parameters for both intra-symbol OCC application and inter-slot OCC application and the parameters indicate two indices and one length of an OCC sequence (e.g., where the UE is configured with multiple slots either for TBoMS or for repetition purposes to enhance coverage), the UE implicitly considers a repetition factor or a number of slots as a length of an OCC sequence for inter-slot OCC application.

In some examples, the NE may indicate for the UE to perform the repetitions 310-a and the repetitions 310-b per symbol 308, as illustrated in FIG. 9. For example, the UE may repeat the contents of a symbol 308 to a next consecutive symbol. The NE may indicate a repetition pattern to the UE in signaling (e.g., RRC signaling, a MAC-CE, and/or a DCI message) that includes the per symbol 308 repetition.

FIG. 10 illustrates an example of a resource diagram 1000 in accordance with aspects of the present disclosure. In some examples, the resource diagram 1000 may implement aspects of the wireless communications system 100, the wireless communications system 200, and the resource diagram 300 through the resource diagram 900. For example, the resource diagram 1000 may include REs 302, an OCC sequence 306-a, an OCC sequence 306-b, a symbol 308, repetitions 310-a, repetitions 310-b, a look up table 314-a, and a look up table 314-b, as described with reference to FIG. 3. The resource diagram 1000 may illustrate an example of combining intra-symbol OCC application and intra-slot OCC application using group-based repetition. The resource diagram 1000 may be implemented by a UE, where the UE may be an example of a UE 104 as described with reference to FIGS. 1 and 2.

In some examples, a UE receives signaling from a NE including a configuration for enabling both types of OCC application (e.g., intra-symbol OCC application and intra-slot OCC application), as described with reference to FIG. 9. The NE may indicate for the UE to perform group-based repetition for the repetitions 310-a and the repetitions 310-b, as illustrated in FIG. 10. For example, the UE may repeat the contents of a set (e.g., group) of symbols 308 to consecutive sets of symbols. The NE may indicate a repetition pattern to the UE in the signaling (e.g., RRC signaling, a MAC-CE, and/or a DCI message) that includes the group-based repetition.

FIG. 11 illustrates an example of a resource diagram 1100 in accordance with aspects of the present disclosure. In some examples, the resource diagram 1100 may implement aspects of the wireless communications system 100, the wireless communications system 200, and the resource diagram 300 through the resource diagram 1000. For example, the resource diagram 1100 may be implemented by a UE, where the UE may be an example of a UE 104 as described with reference to FIGS. 1 and 2. The resource diagram 1100 may illustrate an example of segmenting a TB 1102 into one or more CBs 1104 for inter-slot OCC application.

In some examples, a NE may schedule a UE with a TBoMS. The NE may transmit signaling to the UE to indicate for the UE to apply time and/or and frequency OCC methods to a transmission of a PUSCH 1106 (e.g., a PUSCH transmission) for TBoMS. In some examples, the UE may apply an OCC sequence to the CBs 1104 segmented from a TB 1102 or on the complete TB 1102. In some examples, the UE may apply the OCC sequence within a slot 1108 or across slots 1108 that are scheduled for TBoMS. If the NE configures a UE to apply inter-symbol OCC (e.g., implicitly or explicitly) and the UE is also configured with a number of slots 1108 allocated for processing a TB 1102 over a multi-slot PUSCH (e.g., the PUSCH 1106), then the UE applies the OCC sequence within a slot 1108 by repeating time domain data symbols to the length of the OCC sequence. That is, the UE segments the TB 1102 into the smaller CBs 1104 for respective slots 1108 and applies one complete OCC sequence to the symbols in the slots 1108. The UE can calculate a TBS using a repetition factor due to the OCC sequence application.

A repetition 1110 of the PUSCH 1106 may be contiguous or non-contiguous across symbols within a slot 1108 depending on a received configuration. In some cases, a UE may be configured to apply inter-slot OCC for uplink transmissions including a TB 1102 processed over multiple slots, where the UE is scheduled with a number of slots 1108 for TBoMS. The UE, upon reception of the configuration, may implicitly determine that a number of slots 1108 for repetitions 1110 for inter-slot OCC application include a portion of a number of slots 1108 configured for TBoMS. The UE divides the number of slots 1108 by a length of an OCC sequence to determine a number of actual slots 1108 that are to be used for segmentation of the TB 1102 into the CBs 1104. For example, if a UE is scheduled with a higher layer parameter (e.g., numberOfSlotsTBoMS) that is equal to 4, and the UE is configured with an OCC sequence with a length of 2, then the UE uses 2 slots 1108 for one TB 1102 and two slots for repetitions 1110. Additionally, or alternatively, a UE may be configured with additional slots 1108 for repetitions 1110 resulting from applying the OCC sequence, while the number of slots 1108 configured for TBoMS are for processing the TB 1102.

In some cases, a UE may be configured to perform inter-slot OCC application for TBoMS, and the UE may either apply an OCC sequence across a TB 1102 or may apply an OCC sequence across respective CBs 1104 segmented from the TB 1102 for one slot 1108. That is, the UE maps and transmits the uplink transmission (e.g., the PUSCH 1106) including a TB 1102 over multiple slots 1108 by applying a first codeword of the OCC sequence and then repeating the TB 1102 on a same number of slots 1108 to the length of OCC sequence and applying respective OCC sequences to the repetitions 1110, as illustrated in FIG. 11.

FIG. 12 illustrates an example of a resource diagram 1200 in accordance with aspects of the present disclosure. In some examples, the resource diagram 1200 may implement aspects of the wireless communications system 100, the wireless communications system 200, and the resource diagram 300 through the resource diagram 1100. For example, the resource diagram 1200 may be implemented by a UE, where the UE may be an example of a UE 104 as described with reference to FIGS. 1 and 2. The resource diagram 1200 may illustrate an example of segmenting a TB 1102 into one or more CBs 1104 for inter-slot OCC application.

In some examples, a UE segments a TB 1102 into CBs 1104 allocated to respective slots 1108, where the UE repeats respective CBs 1104 and then applies an OCC sequence across the CBs 1104, as illustrated in FIG. 12. By repeating respective CBs 1104 rather than repeating the TB 1102 on a same number of slots 1108 to the length of OCC sequence and then applying the OCC sequence, as described with reference to FIG. 11, timing drift impact on OCC performance is reduced, as the receiver combines respective CBs with the OCC sequence applied as compared to whole TB that would be mapped on more slots 1108.

In some cases, the NE configures a UE to perform inter-slot OCC application (e.g., implicitly or explicitly), and the UE is also configured with number of slots 1108 allocated for processing the TB 1102 over a multi-slot PUSCH (e.g., the PUSCH 1106). The UE applies an OCC sequence across slots 1108 by repeating the slot 1108 over the multiple slots 1108 that are at least equal to the length of OCC sequence. The UE may not segment the TB 1102 into CBs 1104 corresponding to the length of the assigned slots 1108. Instead, the configuration indicates that a TB 1102 is allocated to one slot 1108 and other slots 1108 are used for repeating the TB 1102 to the length of the OCC sequence. If the NE configures one or more OCC sequences with TBoMS (e.g., along with inter-slot OCC application), then a length of allocated slots 1108 indicates a length of the OCC sequences. If an OCC configuration is received with TBoMS, then the UE uses a slot offset of zero as a default to provide for contiguous slots 1108 for OCC application (e.g., so timing drift does not impact the OCC performance). If TBoMS is used with inter-slot OCC application, then an RV value may be the same (e.g., a fixed RV, RV=0) for inter-slot OCC application with TBoMS. That is, the RV is fixed for the slots 1108 within the scheduled slots 1108 for TBoMS that are being used for inter-slot OCC application.

If a UE is scheduled with multiple slots 1108 for transmitting a TB 1102 over the multiple slots 1108 and the UE is also configured to perform intra-symbol OCC application, then the UE applies a same OCC sequence and a same type of repetition pattern to the PUSCH resources over the multiple slots 1108. That is, the UE applies the OCC sequence in the frequency domain by repeating symbols with a repetition pattern, where a same intra-symbol OCC application process is carried out for the allocated symbols in the multiple slots 1108. Thus, the UE applies a same OCC application process (e.g., pattern) to the CBs 1104 that are segmented from a TB 1102 for a slot 1108. In some examples, the slot offset may be flexible, as is the case of TBoMS without OCC application, because the repetition 1110 is in the frequency domain for OCC application and timing drift does not impact the OCC performance.

If a same OCC sequence and a same type of repetition pattern is used over multiple slots 1108 scheduled for a PUSCH 1106, then a same RV value is used over multiple slots 1108 scheduled with the OCC application (e.g., RV=0). In some cases, a UE may be configured with different OCC sequences and/or repetition patterns for intra-symbol OCC application for respective slots 1108 configured for TBoMS. A NE may configure multiple lengths of an OCC sequence in one configuration either through DCI or RRC signaling, and a UE uses one OCC sequence for each of the configured slots 1108. For example, a UE receives a configuration from the NE, where the configuration indicates two indices of OCC sequences. The UE may also receive a TBoMS configuration of 2 slots. The UE applies a first OCC sequence to a first slot and a second OCC sequence to a second slot. Thus, the NE may efficiently utilize the frequency resources in scheduling multiple UEs. Additionally or alternatively, a NE may configure a UE to apply TB repetitions for an uplink transmission of a TBoMS, and a UE may additionally be configured to perform an OCC application. The UE may apply the OCC sequence in slots that are scheduled for TBoMS and repeat the same slots with a same OCC sequence over the other slots used for repetitions. For example, if a UE is scheduled to apply TB repetitions for an uplink transmission of TBoMS and to perform inter-symbol OCC application, then the UE applies an OCC sequence over the segmented CBs 1104 for the slots that are configured for TBoMS (e.g., configured by a higher layer parameter numberOfSlotsTBoMS), and then repeats the same OCC sequence over multiple slots that are configured for repetitions. That is, the UE transmits the TB 1102 across NK slots, where N is a number of slots scheduled for TBoMS and K is the slots configured for repetitions. The NK slots are for the PUSCH transmission. The UE applies a same symbol allocation to each slot and a same OCC sequence to each slot.

If a NE indicates for a UE to perform inter-slot OCC application and the UE is also configured with parameters indicating TB repetitions with TBoMS for an uplink transmission, then the UE may determine that a number of configured repetitions implicitly indicates a length of an OCC sequence. The UE may apply an OCC sequence by repeating the slots in a TBoMS to a length of the OCC sequence and may use one codeword from the OCC sequence to for the slots configured for the TBoMS. If TBoMS is repeated for the purpose of inter-slot OCC application, then the UE implicitly determines that the RV parameter is fixed (e.g., RV is set to zero for all the transmission occasions). For example, if N is a number of slots scheduled for TBoMS and K are the slots configured for repetitions, then RV=0 for the transmission occasions n 0, 1, . . . , N-K-1. In some cases, the UE transmits a repetition of the PUSCH data if at least one slot in the slots configured for repetition is within an inactive period of a cell-DRX (C-DRX), an inactive period of c-DRX, or any combination thereof, and if a slot corresponding to an original transmission of the PUSCH data is within an active period of the C-DRX, an active period of the cell DRX, or any combination thereof. In some other cases, the UE is not expected to transmit a repetition of the PUSCH data if at least one slot in the slots configured for repetition is within an active period of a C-DRX, an active period of cell DRX, or any combination thereof, and if a slot corresponding to an original transmission of the PUSCH data is within an inactive period of the C-DRX, an inactive period of the cell DRX, or any combination thereof.

In some examples, the UE may calculate a TBS for a time domain OCC application (e.g., inter-slot OCC application or intra-slot OCC application). For example, if a PUSCH is scheduled dynamically by a DCI message, a PUSCH is scheduled by a RAR uplink grant, or a PUSCH is scheduled by a configured grant, if transform precoding is enabled, and if OCC application is enabled for the time domain in a slot (e.g., inter-symbol), then the UE may calculate the TBS implicitly based on the indicated length of an OCC sequence. For example, the UE determines one or more actual information bits excluding the resources allocated for repeated time domain symbols in a slot. The UE excludes the OCC symbol repetition for OCC application in the TBS calculation by dividing by a length of the OCC sequence while calculating the number of REs within a PRB for a slot for PUSCH. For example, if an OCC sequence is configured for inter-symbol type application, the UE determines a number of REs allocation per RB available for PUSCH within a PRB,

$$( {N}_{RE}^{′} ) , by {N}_{RE}^{′} = ( {N}_{sc}^{RB} \cdot {N}_{symb}^{sh} - {N}_{DMRS}^{PRB} - {N}_{oh}^{PRB} ) / {N}_{L}^{TD - OCC} ,$$

where

$${N}_{L}^{TD - OCC}$$

is a length of a configured OCC sequence for applying the OCC sequence across the time domain symbol. If inter-symbol OCC application is not enabled, then by default, the UE may use a value of

$${N}_{L}^{TD - OCC} = 1.$$

If the OCC sequence is applied across slots with slot based repetitions (e.g., the repetitions are configured across slots) and the OCC sequence is also applied across slots, then the UE uses

$${N}_{L}^{TD - OCC} = 1.$$

In some examples, the UE may calculate a TBS for a multiple OCC applications (e.g., inter-slot OCC application, intra-slot OCC application, and/or intra-symbol OCC application). For example, if a UE is configured to apply OCC sequences on both time and frequency resources for an uplink transmission (e.g., to multiplex additional UEs), then the TBS calculation incorporates the time and frequency resources for the repetition. If the UE uses intra-symbol and inter-symbol OCC application methods jointly, then the UE excludes the repetitions of the frequency and time resources while calculating the number of REs within a PRB for a slot for PUSCH. For example, the UE determines a number of REs allocation per RB available for PUSCH within a PRB,

$$( {N}_{RE}^{′} ) , by {N}_{RE}^{′} = ( {N}_{sc}^{RB} \cdot {N}_{symb}^{sh} - {N}_{DMRS}^{PRB} - {N}_{oh}^{PRB} ) / ( {N}_{L}^{FD - OCC} \cdot {N}_{L}^{TD - OCC} ) ,$$

where

$${N}_{L}^{FD - OCC}$$

is a length of a configured OCC sequence for intra-symbol OCC application and

$${N}_{L}^{TD - OCC}$$

is a length of a configured OCC sequence for applying the OCC sequence across the symbols in the slot. If the UE uses inter-slot and intra-symbol OCC application methods jointly and the UE is additionally configured with slot repetitions, where the length of configured slot repetitions is equal to the inter-slot OCC length, then the UE calculates a number of REs allocation per RB available for PUSCH within a PRB,

$$( {N}_{RE}^{′} ) , by {N}_{RE}^{′} = ( {N}_{sc}^{RB} \cdot {N}_{symb}^{sh} - {N}_{DMRS}^{PRB} - {N}_{oh}^{PRB} ) / ( {N}_{L}^{FD - OCC} \cdot {N}_{L}^{TD - OCC} ) with {N}_{L}^{T D - O C C} = 1.$$

In some examples, the UE may calculate a TBS for OCC application using TBoMS. If a PUSCH is scheduled for uplink transmissions with TB processing over multiple slots and an OCC application is also configured, then depending on the technique implementation for TBoMS, different ways to calculate the TBS may be identified and the UE adopts one of the ways to calculate the TBS based on the OCC application. For example, if intra-symbol, intra-slot, and inter-slot OCC application techniques are used for TBoMS and a number of configured slots for TBoMS include slots used for repetition, then the UE may calculate the TBS implicitly based on the indicated length of OCC sequence by excluding the resources that are used for repetition. For example, if an OCC sequence is configured for TBoMS, then the UE determines a number of REs allocation per RB available for PUSCH within a PRB,

$$( {N}_{R E}^{′} ) , by {N}_{R E}^{′} = ( {N}_{sc}^{R B} \cdot {N}_{s y m b}^{s h} - {N}_{D M R S}^{P R B} - {N}_{o h}^{P R B} ) / {N}_{L}^{T B o M S - O C C} ,$$

where

$${N}_{L}^{T B o M S - O C C}$$

is a length of a configured OCC sequence for applying the OCC sequence across slots scheduled for the TBoMS. Once the number of RE allocation per RB is calculated, then the UE determines a total number of REs allocated for PUSCH by

$${N}_{R E} = N * min ( 156 , {N}_{R E}^{′} ) \cdot {n}_{P R B} ,$$

where n_{PRB} is a total number of allocated PRBs for the UE and N is the number of slots used for TBS determination indicated by numberOfSlotsTBoMS.

In some cases, if the UE uses inter-slot OCC application techniques with TBoMS and the slots used for repetitions (e.g., to apply inter-slot) are configured (e.g., by another parameter repK), where the number of repetition slots is equal to the OCC length times the TBoMS slots, then the UE determines a number of REs allocation per RB available for PUSCH within a PRB,

$$( {N}_{R E}^{′} ) , by {N}_{R E}^{′} = ( {N}_{sc}^{R B} \cdot {N}_{s y m b}^{s h} - {N}_{D M R S}^{P R B} - {N}_{o h}^{P R B} ) / {N}_{L}^{T B o M S - O C C} ,$$

where

$${N}_{L}^{T B o M S - O C C} = 1.$$

A total number of REs allocated for PUSCH (N_{RE}) is equal to

$${N}_{R E} = N * min ( 156 , {N}_{R E}^{′} ) \cdot {n}_{P R B} .$$

In some examples, a value of

$${N}_{L}^{T B o M S - O C C}$$

does not include slots falling within an inactive period of the C-DRX, an inactive period of the c-DRX, or any combination thereof.

FIG. 13 illustrates an example of a resource diagram 1300 in accordance with aspects of the present disclosure. In some examples, the resource diagram 1300 may implement aspects of the wireless communications system 100, the wireless communications system 200, and the resource diagram 300 through the resource diagram 1200. For example, the resource diagram 1300 may be implemented by a UE 1 and a UE 2, where the UE 1 and the UE 2 may be examples of UEs 104 as described with reference to FIGS. 1 and 2. The resource diagram 1300 may illustrate an example of intra-slot frequency hopped OCC application.

In some examples, a UE (e.g., the UE 1 and/or the UE 2) applies an OCC sequence along with frequency hopping. Combining frequency hopping with OCC application provides for improved interference management, improved reliability, increased capacity, and improved mitigation of multipath and Doppler effects. Techniques to mitigate the Doppler effects are beneficial for non-terrestrial systems, where Doppler impacts performance due to movement of satellites, as well as for terrestrial systems. In some cases, the UE may apply an OCC sequence with frequency hopping (e.g., OCC application by repetition across different carrier frequencies with a frequency offset 1302) for an uplink transmission. The uplink transmission may be an example of a PUSCH transmission.

For example, the UE may perform intra-slot, inter-slot and inter-symbol OCC application with sub-slot and/or intra-slot frequency hopping. Additionally, or alternatively, the UE may perform intra-slot, inter-slot and inter-symbol OCC application with multiple repetitions across multiple hops (e.g., to a length of an OCC sequence) using intra-slot frequency hopping. Additionally, or alternatively, the UE may use a same or a different OCC sequence application by repeating the symbols in each hop. Additionally, or alternatively, the UE may perform intra-slot, inter-slot, and inter-symbol OCC application with sub-slot inter-slot frequency hopping. If a UE is configured with frequency hopping (e.g., with or without inter-repetition), then the UE may additionally be configured to apply an OCC sequence on top of frequency hopping. A NE may explicitly or implicitly indicate to the UE that the OCC sequence is applied to time resources of a slot, frequency resources of symbols in the slot, and/or time resources of multiple slots.

If a UE is configured with intra-slot frequency hopping and additionally configured with an OCC index (e.g., for a PUSCH repetition type 1), then the UE implicitly selects an OCC sequence from a length 2 look up table (e.g., the look up table 314-b, which may be an example of a look up table 314 as described with reference to FIG. 3). For example, the UE 1 selects an OCC sequence 306-a from the look up table 314-b and the UE 2 selects an OCC sequence 306-b from the look up table 314-b. The UE applies the OCC sequence across frequency hopped symbols by implicitly repeating a same number of RBs on different sets of frequencies to have frequency diversity on top of the OCC sequence (e.g., to obtain the repetitions 310, which may be examples of the repetitions 310 as described with reference to FIG. 3). For example, the UE 1 applies the OCC sequence 306-a across one or more frequency resources (e.g., RBs) for a portion of symbols 1304 and one or more frequency resources for a remaining portion of the symbols 1306. In some other examples, the UE 2 applies the OCC sequence 306-b across one or more frequency resources (e.g., RBs) for a portion of symbols 1304 and one or more frequency resources for a remaining portion of the symbols 1306.

If the OCC sequence 306-a and/or the OCC sequence 306-b have a length of 2, then the portion of symbols is half of the symbols, and the remaining portion of the symbols includes the other half of the symbols. The offset 1302 can include any numerical quantity of frequency resources (e.g., RBs, REs, or any other frequency resources). The NE can indicate the frequency offset 1302 to the UE 1 and/or the UE 2 via signaling (e.g., RRC signaling, a MAC-CE, or a DCI message).

If a UE (e.g., the UE 1 and/or the UE 2) is scheduled for intra-slot frequency hopping along with a frequency offset 1302 (e.g., provided by a higher layer parameter), then a starting RB in each hop is given by Equation 1:

$$R {B}_{start} = \{ \begin{matrix}R {B}_{start} & i = 0 \\ ( R {B}_{start} + {RB}_{offset} ) mod {N}_{BWP}^{size} & i = 1\end{matrix} , \qquad ( 1 )$$

where I=0 and I=1 are the first hop and the second hop, respectively, and RBₛₜₐᵣₜ is the starting RB within the uplink BWP (e.g., calculated from the resource block assignment information of resource allocation type) and RB_{offset} is the frequency offset 1302 in RBs between the two frequency hops. The number of symbols in the first hop would be given by

$$⌊ {N}_{s y m b}^{P U S C H , s} / 2 ⌋ ,$$

the number of symbols in the second hop is given by

$${N}_{s y m b}^{P U S C H , s} - ⌊ {N}_{s y m b}^{P U S C H , s} / 2 ⌋ ,$$

where

$${N}_{s y m b}^{P U S C H , s}$$

is the length of the PUSCH transmission in OFDM symbols in one slot. If a UE is additionally configured with an index for an OCC sequence from a look up table, then the UE selects the OCC sequence for that index and applies the first codeword of the sequence to the symbols of a first hop. The UE repeats the data on the RBs of the symbols of the second hop, where the number of RBs associated with the second hop symbols would be equal to the number of RBs associated with the first hop symbols. The UE applies the second codeword of the sequence to the symbols of second hop. The UE may receive an explicit indication to use length 2 sequence for intra-slot frequency hopping.

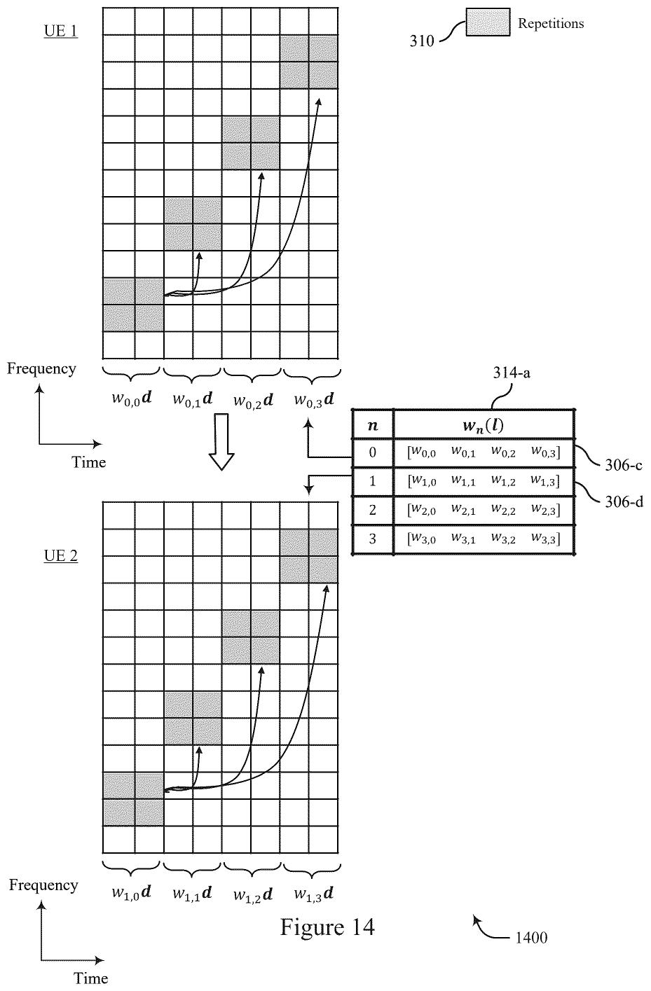

FIG. 14 illustrates an example of a resource diagram 1400 in accordance with aspects of the present disclosure. In some examples, the resource diagram 1400 may implement aspects of the wireless communications system 100, the wireless communications system 200, and the resource diagram 300 through the resource diagram 1300. For example, the resource diagram 1400 may be implemented by a UE 1 and a UE 2, where the UE 1 and the UE 2 may be examples of UEs 104 as described with reference to FIGS. 1 and 2. The resource diagram 1400 may illustrate an example of intra-slot frequency hopped OCC application.

In some examples, a UE (e.g., a UE 1 and/or a UE 2) is configured to apply inter-repetition frequency hopping (e.g., repetitions 310 within a slot along with frequency hopping for PUSCH repetition type B), and the UE is additionally configured to apply an OCC sequence. The UE may apply a codeword from an OCC sequence on each of the repetitions 310 at different frequencies. In some examples, the UE selects a look up table 314-a (e.g., a look up table from a defined list of look up tables) that corresponds to a number of repetitions that are configured, where the repetitions 310 and the look up table 314-a may be examples of the repetitions 310 and the look up table 314 as described with reference to FIG. 3. Additionally, or alternatively, the NE does not configure a number of repetitions at the UE. The NE may indicate a length of an OCC sequence. The UE may implicitly determine that the length of the OCC sequence is the same as the number of repetitions for OCC application in a slot with frequency hopping.

For example, if a NE configures a UE with a repetition number for a slot or with a length of an OCC, and the UE is configured with intra-slot frequency hopping with a frequency offset, then the UE calculates a starting RB for n-th repetition according to Equation 2:

$$R {B}_{start} ( n ) = \{ \begin{matrix}R {B}_{start} & n mod 2 = 0 \\ ( R {B}_{start} + {RB}_{offset} ) mod {N}_{BWP}^{size} & n mod 2 = 1 ,\end{matrix} \qquad ( 2 )$$

where n is a number of repetitions corresponding to the length of the OCC sequence. For example, for a length of an OCC sequence equal to 4, either the length of 4 is configured or a repetition factor of 4 is indicated to the UE by the NE. The NE may indicate the length of the OCC sequence and/or the repetition factor as part of dynamic signaling in DCI or MAC-CE and/or through higher layer signaling (e.g., in a PUSCH configuration or in a configured grant resource allocation). The UE may divide a number of time domain symbols in a slot into four equal sets of time domain symbols, where for each of the symbols in a slot, the starting RB is calculated with a same offset and the number of RBs are the same for each set of symbols. The UE selects an OCC sequence with a length of four from a look up table according to a configured index and applies one codeword from the OCC sequence to each of the repeated symbols where each of the repeated symbols have different carrier frequencies, as shown in FIG. 14.

For example, the UE 1 selects an OCC sequence 306-c from the look up table 314-a, while the UE 2 selects an OCC sequence 306-d from the look up table 314-a, where the OCC sequence 306-c and the OCC sequence 306-d are examples of OCC sequences as described with reference to FIGS. 1 through 14. The UE 1 applies the OCC sequence 306-c (e.g., codewords from the OCC sequence 306-c) to respective repeated symbols, where the respective repeated symbols have different carrier frequencies. The UE 2 applies the OCC sequence 306-d (e.g., codewords from the OCC sequence 306-d) to respective repeated symbols, where the respective repeated symbols have different carrier frequencies.

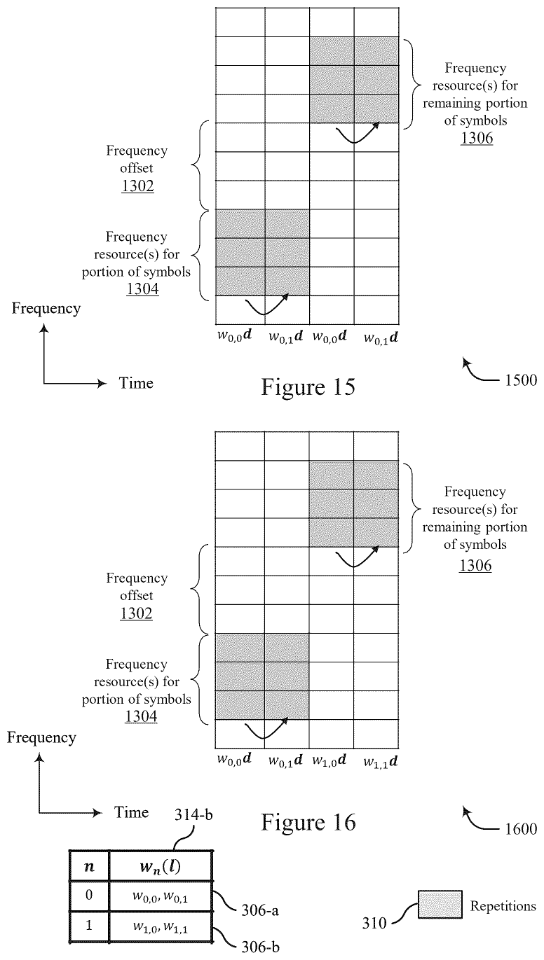

FIG. 15 illustrates an example of a resource diagram 1500 in accordance with aspects of the present disclosure. In some examples, the resource diagram 1500 may implement aspects of the wireless communications system 100, the wireless communications system 200, and the resource diagram 300 through the resource diagram 1400. For example, the resource diagram 1500 may be implemented by a UE, where the UE may be an example of a UE 104 as described with reference to FIGS. 1 and 2. The resource diagram 1500 may illustrate an example of intra-slot OCC application and frequency hopping using a same OCC sequence per frequency hop.

In some examples, a UE receives a configuration to apply intra-slot OCC and frequency hopping without an explicit indication of inter-repetition for frequency hopping (e.g., for PUSCH repetition type A). The UE may apply an OCC sequence in each hop by repeating the symbols in each hop, where the same sequence may be applied across hops. For example, a NE configures the UE with a frequency offset 1302 and the UE repeats frequency resources for a portion of symbols 1304 and frequency resources for a remaining portion of symbols 1306, where the offset 1302, the frequency resources for the portion of symbols 1304, and the frequency resources for the remaining portion of the symbols 1306, are examples of the offset 1302, the frequency resources for the portion of symbols 1304, and the frequency resources for the remaining portion of the symbols 1306 as described with reference to FIG. 13. The UE selects an OCC sequence, such as the OCC sequence 306-a, from a look up table 314-b (e.g., a look up table 314, as described with reference to FIG. 3) to apply to both the frequency resources for the portion of symbols 1304 and the frequency resources for the remaining portion of the symbols 1306.

If a UE is configured with an OCC sequence with a length of 2 and four symbols, where intra-slot frequency hopping is enabled at the UE, then the UE divides the symbols for each hop by two. Then the UE repeats the first symbol to the next symbol in the first hop and applies each codeword of the OCC sequence to the two symbols. The UE maps the data on the frequency domain resources with a configured RB offset. The UE repeats the second hop symbols according to OCC length and applies OCC sequence to the repeated symbols.

FIG. 16 illustrates an example of a resource diagram 1600 in accordance with aspects of the present disclosure. In some examples, the resource diagram 1600 may implement aspects of the wireless communications system 100, the wireless communications system 200, and the resource diagram 300 through the resource diagram 1500. For example, the resource diagram 1600 may be implemented by a UE, where the UE may be an example of a UE 104 as described with reference to FIGS. 1 and 2. The resource diagram 1600 may illustrate an example of intra-slot OCC application and frequency hopping using different OCC sequences per frequency hop.

In some examples, a UE may use a different OCC sequence for each hop, where the NE may indicate multiple OCC sequences to be used for respective hops to the UE (e.g., in RRC signaling, a DCI message, or in a MAC-CE). In some examples, if two hops are used for frequency hopping (e.g., by dividing the number of configured symbols in a slot by two), then a UE may implicitly use alternative OCC sequences for the two hops. Thus, if the UE uses a first OCC sequence in a first hop, then the UE uses a second OCC sequence in a second hop. A NE configures the UE with a frequency offset 1302 and the UE repeats frequency resources for a portion of symbols 1304 and frequency resources for a remaining portion of symbols 1306, where the offset 1302, the frequency resources for the portion of symbols 1304, and the frequency resources for the remaining portion of the symbols 1306, are examples of the offset 1302, the frequency resources for the portion of symbols 1304, and the frequency resources for the remaining portion of the symbols 1306 as described with reference to FIG. 13. The UE selects multiple OCC sequences, such as the OCC sequence 306-a and the OCC sequence 306-b, from a look up table 314-b (e.g., a look up table 314, as described with reference to FIG. 3) to apply to the frequency resources for the portion of symbols 1304 and the frequency resources for the remaining portion of the symbols 1306, respectively. For example, the UE applies different OCC sequences to the frequency resources for the portion of symbols 1304 and the frequency resources for the remaining portion of the symbols 1306.

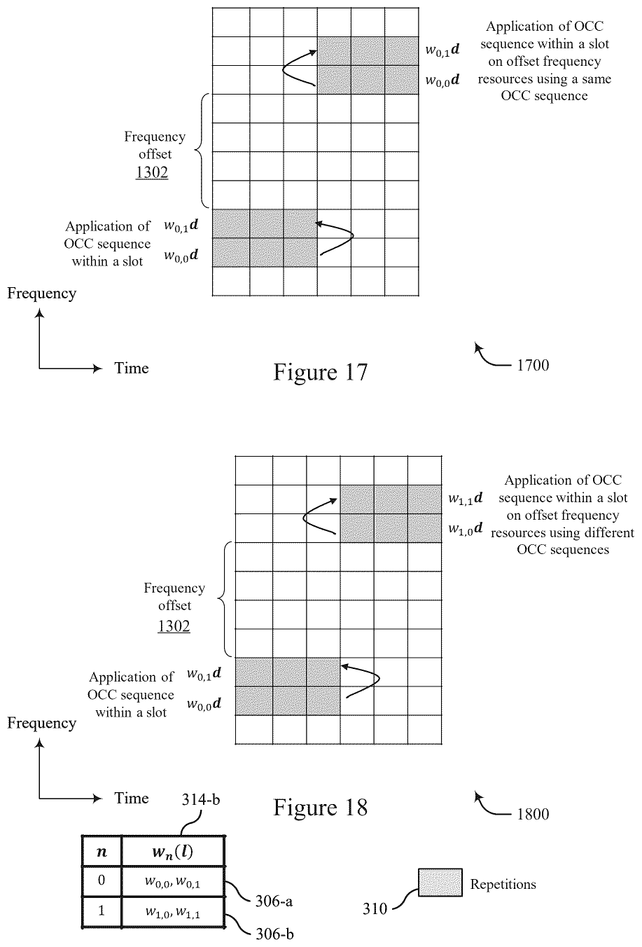

FIG. 17 illustrates an example of a resource diagram 1700 in accordance with aspects of the present disclosure. In some examples, the resource diagram 1700 may implement aspects of the wireless communications system 100, the wireless communications system 200, and the resource diagram 300 through the resource diagram 1600. For example, the resource diagram 1700 may be implemented by a UE, where the UE may be an example of a UE 104 as described with reference to FIGS. 1 and 2. The resource diagram 1700 may illustrate an example of intra-symbol OCC application and intra-slot frequency hopping using a same OCC sequence on frequency hopped RBs.

In some examples, if intra-symbol OCC application is configured and intra-slot frequency hopping is also configured at a UE (e.g., by a NE via RRC signaling, one or more DCIs, one or more MAC-CEs, or any other control signaling), then the UE may perform intra-symbol OCC application across the frequency hops. For example, the UE may use a same intra-symbol OCC application pattern across the frequency hops. The intra-symbol OCC application pattern may include an OCC sequence with a length and a corresponding index, an application method (e.g., the UE applies the OCC sequence in a time domain or in a frequency domain, before DFT, including for DFT-s-OFDM, or after DFT), a repetition pattern (e.g., single RE-based repetition or group of REs-based repetition), and an application pattern (e.g., RB-based or RE-based). For example, the UE may use a same OCC sequence 306-a selected from a look up table 314-b across the frequency hops according to the frequency offset 1302, where the OCC sequence 306-a, the look up table 314-b, and the offset 1302 may be examples of the corresponding features as described with reference to FIGS. 1 through 16.

FIG. 18 illustrates an example of a resource diagram 1800 in accordance with aspects of the present disclosure. In some examples, the resource diagram 1800 may implement aspects of the wireless communications system 100, the wireless communications system 200, and the resource diagram 300 through the resource diagram 1700. For example, the resource diagram 1700 may be implemented by a UE, where the UE may be an example of a UE 104 as described with reference to FIGS. 1 and 2. The resource diagram 1700 may illustrate an example of intra-symbol OCC application and intra-slot frequency hopping using different OCC sequences on frequency hopped RBs.

In some examples, if intra-symbol OCC application is configured and intra-slot frequency hopping is also configured at a UE, then the UE upon receiving such configuration may perform intra-symbol OCC application across the frequency hops. For example, the UE may use different intra-symbol OCC application patterns across the frequency hops. An intra-symbol OCC application pattern may include an OCC sequence of length and index, an application method (e.g., applied in a time domain before DFT for DFT-s-OFDM or applied in a frequency domain), a repetition pattern (e.g., single RE-based repetition or group of REs-based repetition), and an application pattern (e.g., RB-based or RE-based). For example, if a UE is to use two frequency hops with an RB offset and length 2 intra-symbol OCC with application across RBs, then the UE uses a first OCC sequence for the first hop by repeating the RBs. In a second hop, the UE repeats the data again across RBs and applies a different OCC sequence. For example, the UE may use an OCC sequence 306-a selected from a look up table 314-b for a first frequency hop and an OCC sequence 306-b selected from the table 314-b for a second frequency hop according to the frequency offset 1302, where the OCC sequence 306-a, the look up table 314-b, and the offset 1302 may be examples of the corresponding features as described with reference to FIGS. 1 through 17.

In some cases, a UE may be configured to perform intra-symbol and intra-slot OCC applications along with frequency hopping. For intra-symbol OCC applications, a UE applies at least one OCC sequence across frequency domain resources (e.g., by repeating frequency domain resources, REs, or RBs) in each of the hops. For intra-slot OCC applications, a UE applies at least one OCC sequence across hops by repeating the RBs of each hop across the hops. If a UE is configured to perform intra-symbol OCC application and intra-slot frequency hopping without inter-repetition, then the UE may additionally be configured with a single length of an OCC sequence for the intra-symbol OCC application, a single index for the intra-symbol OCC application, and one index for intra-slot OCC application. The UE performs the intra-symbol OCC application across REs or RBs of two hops and implicitly performs the intra-slot OCC application of length 2 by repeating the symbols in a first hop to symbols in a second hop. In some cases, intra-slot frequency hopping may include frequency hopping across sub-slots (e.g., if slot consists of 14 symbols, then the second hop with a frequency offset would start at least 8^{th} symbol) or frequency hopping may include an RB offset to the contiguous time domain data symbols.

If a UE is configured with inter-slot frequency hopping (e.g., with or without inter-repetition), then the UE may additionally be configured to apply an OCC sequence with frequency hopping. The NE may implicitly or explicitly indicate to the UE that the OCC sequence is applied to the time domain resources of time resources of multiple slots. In some cases, a UE receives a configuration to apply inter-slot frequency hopping (e.g., with or without repetition) and the UE is additionally configured with inter-slot OCC application with a length of an OCC sequence. The UE implicitly determines that a number of repetitions to be used for the calculation of a starting RB is equal to a length of the OCC sequence. The UE repeats the data across slots (e.g., the number of slots is equal to a length of the OCC sequence) in same time resources but on different frequency resources of the slots (e.g., frequency resources of each slot would differ with a configured RB offset). The UE may apply a codeword from the configured OCC sequence on each of the slots.

For example, for inter-slot frequency hopping and inter-slot OCC application, a starting RB during slot

$${n}_{s}^{l}$$

is given by Equation 3:

$$R {B}_{start} ( {n}_{s}^{l} ) = \{ \begin{matrix}R {B}_{start} & {n}_{s}^{l} mod 2 = 0 \\ ( R {B}_{start} + {RB}_{offset} ) mod {N}_{BWP}^{size} & {n}_{s}^{l} mod 2 = 1\end{matrix} , \qquad ( 3 )$$

where

$${n}_{s}^{l}$$

is the current slot number within a system radio frame corresponding to the codeword number from an OCC sequence of length l. In some cases, if a UE is configured with multi-slot PUSCH transmission with a slot repetition number and inter-slot frequency hopping, then the UE may implicitly use the slot repetition number as a length of the OCC sequence. The UE repeats each of the slots on same time resources and a same number of frequency resources at different carrier frequencies. The UE applies the OCC sequence across the slots. A UE may be configured to apply frequency hopping in a slot or across slots and according to multiple OCC application methods (e.g., inter-symbol, intra-slot, and inter-slot are applied in combinations). The NE implicitly or explicitly indicates for the UE to apply the combination of methods based on an implicit or explicit indication from network. A UE may be configured to perform either intra-symbol or inter-symbol OCC application techniques along with inter-slot OCC application and may additionally be configured to apply inter-slot frequency hopping. Additionally, or alternatively, the UE may be configured to apply either of intra-symbol or inter-symbol OCC techniques along with inter-slot frequency hopping.

In some examples, the UE implicitly determines that either an OCC sequence is to be applied across frequency resources of each slot (e.g., intra-symbol OCC) or across time domain data symbols (e.g., inter-symbol) based on the received configuration. The UE applies inter-slot frequency hopping and may not apply inter-slot repetitions for OCC application. Thus, the UE may use a same length of an OCC sequence, OCC sequence index, repetition pattern (e.g., RE-based or RB-based) across the slots, but the UE may not repeat the data across the slots (e.g., as is the case for TB segmentation to apply segmented CBs over multiple slots).

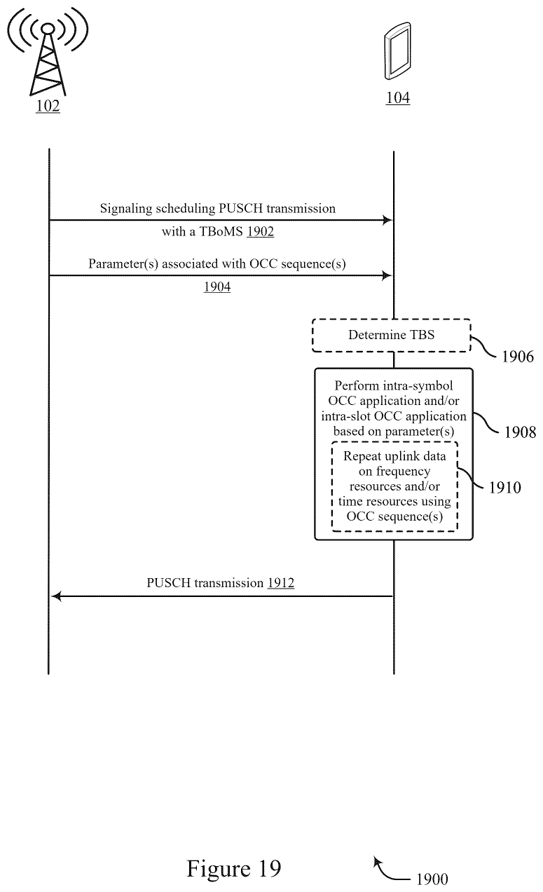

FIG. 19 illustrates an example of a signaling diagram 1900 in accordance with aspects of the present disclosure. In some examples, the signaling diagram 1900 may implement aspects of the wireless communications system 100, the wireless communications system 200, and the resource diagram 300 through the resource diagram 1800. For example, the signaling diagram 1900 may be implemented by a UE 104 and a NE 102, where the UE 104 and the NE 102 may be examples of the corresponding devices as described with reference to FIGS. 1 and 2. The signaling diagram 1900 may illustrate an example of OCC application for an uplink transmission that includes a TBoMS. Alternative examples of the following may be implemented, where some processes are performed in a different order than described or are not performed. In some cases, processes may include additional features not mentioned below, or further processes may be added.

At 1902, the NE 102 transmits signaling scheduling a PUSCH transmission with a TBoMS. For example, the NE 102 transmits a configured grant, or any other control signaling, that schedules the PUSCH transmission with a TBoMS.

At 1904, the NE 102 transmits one or more parameters associated with one or more OCC sequences to the UE 104. For example, the NE 102 transmits signaling to the UE 104 that includes the parameters. The signaling may include RRC signaling, a DCI message, or a MAC-CE, with RRC signaling indicating a set of parameters that are then activated by the DCI message or the MAC-CE. Example parameters include, but are not limited to, a first parameter that indicates multiple types of OCC sequences are enabled or disabled, a second parameter that indicates a length of the OCC sequences, a third parameter that indicates an index of the OCC sequences in a list (e.g., look up table) of OCC sequences, and a fourth parameter that indicates one or more repetition types for repeating uplink data of the PUSCH transmission, among other examples. In some cases, the UE 104 and/or the NE 102 determines a length of the OCC sequences using a duration (e.g., length) or numerical quantity of the slots. In some examples, a slot offset for the slots is zero and respective RVs of the slots are a same value.

In some cases, at 1906, the UE 104 determines a TBS. For example, the UE 104 determines the TBS using a length of the OCC sequences (e.g., the OCC sequence for OCC application in a time domain and/or a frequency domain) or a numerical quantity of slots allocated for repetitions of uplink data of the PUSCH transmission. In some examples, the TBS is a size of the TB included in the PUSCH transmission. In some cases, the parameters implicitly or explicitly indicate the TBS.

At 1908, the UE 104 performs intra-symbol OCC application and/or intra-slot OCC application based on the parameters. For example, the UE 104 applies the at least one OCC sequence to the PUSCH transmission within respective slots of the PUSCH transmission, across the respective slots of the PUSCH transmission, or both.

In some cases, at 1910, the UE 104 repeats uplink data on frequency resources and/or on time resources using one or more OCC sequences. The uplink data is uplink data from the PUSCH transmission (e.g., the TB and/or one or more CBs of the TB). The UE 104 repeats the uplink data using a length of the OCC sequences and by applying the OCC sequences to the PUSCH transmission within the respective slots, across the respective slots, or both.

In some examples, the UE 104 repeats uplink data of respective symbols of the slots or respective sets of symbols of the slots (e.g., repetition type 1 or repetition type 2) using a length of the at least one OCC sequence. For example, the parameters indicate for the UE 104 to apply the OCC sequence to the PUSCH transmission within the respective slots, the PUSCH transmission includes multiple repetitions of the uplink data on respective symbols or the respective sets of symbols, and the repetitions are performed using one or more RBs in a frequency domain (e.g., RB-based repetitions). The UE may apply a same OCC sequence to the slots assigned for the TBoMS if the UE applies a same repetition type (e.g., repetition type 1 or repetition type 2) to the data within the slots. Additionally, or alternatively, the one or more parameters indicate multiple OCC sequences to apply to the slots or multiple repetition types to apply to the data within the slots.

In some cases, the one or more parameters indicate for the UE 104 to apply the OCC sequence to the PUSCH transmission across the slots at a TB level of granularity or at a CB level of granularity. The slots may include a first portion of slots allocated for the TB and a second portion of slots allocated for repetitions of uplink data of the PUSCH transmission. A UE determines a numerical quantity of slots in the first portion of slots using a length of the at least one OCC sequence. In some cases, slots of the first portion of slots have a same symbol allocation and slots of the first portion of slots have a same OCC sequence. A UE 104 may determine to transmit at least one repetition if at least one slot of the second portion of slots is within an inactive period of a DRX cycle of the UE and at least one slot of the first portion of slots is within an active period of the DRX cycle. Additionally, or alternatively the UE 104 may determine to cancel transmission of (e.g., not transmit, refrain from transmitting) at least one repetition if at least one slot of the second portion of slots is within an active period of the DRX cycle and at least one slot of the first portion of slots is within an inactive period of the DRX cycle.

At 1912, the UE 104 transmits the PUSCH transmission to the NE 102. For example, the UE 104 transmits the PUSCH transmission including the TB over the slots allocated for the TBoMS (e.g., via the signaling at 1902).

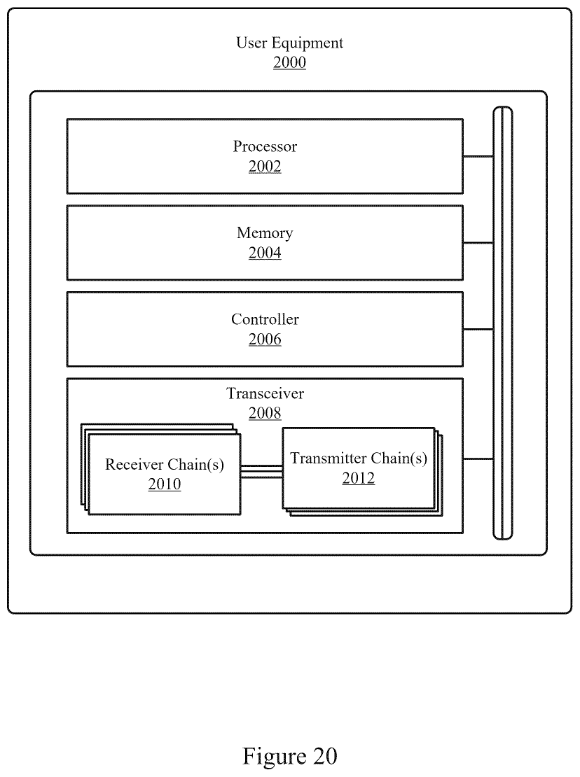

FIG. 20 illustrates an example of a UE 2000 in accordance with aspects of the present disclosure. The UE 2000 may include a processor 2002, a memory 2004, a controller 2006, and a transceiver 2008. The processor 2002, the memory 2004, the controller 2006, or the transceiver 2008, or various combinations thereof or various components thereof may be examples of means for performing various aspects of the present disclosure as described herein. These components may be coupled (e.g., operatively, communicatively, functionally, electronically, electrically) via one or more interfaces.

The processor 2002, the memory 2004, the controller 2006, or the transceiver 2008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2002 may include an intelligent hardware device (e.g., a general-purpose processor, a DSP, a CPU, an ASIC, an FPGA, or any combination thereof). In some implementations, the processor 2002 may be configured to operate the memory 2004. In some other implementations, the memory 2004 may be integrated into the processor 2002. The processor 2002 may be configured to execute computer-readable instructions stored in the memory 2004 to cause the UE 2000 to perform various functions of the present disclosure.

The memory 2004 may include volatile or non-volatile memory. The memory 2004 may store computer-readable, computer-executable code including instructions when executed by the processor 2002 cause the UE 2000 to perform various functions described herein. The code may be stored in a non-transitory computer-readable medium such as the memory 2004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2002 and the memory 2004 coupled with the processor 2002 may be configured to cause the UE 2000 to perform one or more of the functions described herein (e.g., executing, by the processor 2002, instructions stored in the memory 2004). For example, the processor 2002 may support wireless communication at the UE 2000 in accordance with examples as disclosed herein. The UE 2000 may be configured to or operable to support a means for receiving first signaling that schedules a PUSCH transmission including a TB over a set of slots, receiving second signaling that indicates one or more parameters associated with at least one OCC sequence, applying the at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, and transmitting the PUSCH transmission during the set of slots.

Additionally, the UE 2000 may be configured to support any one or combination of repeating, based on a length of the at least one OCC sequence and the at least one OCC sequence being applied to the PUSCH transmission for the respective symbols of the respective slots of the set of slots, the at least one OCC sequence is applied to the PUSCH transmission for the respective slots of the set of slots, or both, uplink data associated with the PUSCH transmission on a set of frequency resources or time resources. Additionally, or alternatively, the UE 2000 may be configured to support repeating, based on a length of the at least one OCC sequence, uplink data associated with at least one of the respective symbols of the set of slots or respective sets of symbols of the set of slots, and where the one or more parameters indicate for the UE to apply the at least one OCC sequence to the PUSCH transmission for the respective symbols of the respective slots of the set of slots, the PUSCH transmission includes a set of repetitions of the uplink data associated with the respective symbols or the respective sets of symbols, and the set of repetitions are associated with resource blocks in a frequency domain. Additionally, or alternatively, the set of slots is associated with a same OCC sequence, and the set of slots is associated with a same repetition type. Additionally, or alternatively, the one or more parameters indicate one or more of a set of OCC sequences corresponding to the respective slots of the set of slots or a set of repetition types corresponding to the respective slots of the set of slots.

Additionally, or alternatively, the one or more parameters indicate for the UE to apply the at least one OCC sequence to the PUSCH transmission for the respective slots of the set of slots based on the transport block or a CB associated with the transport block, the set of slots includes a first portion of slots allocated for the transport block and a second portion of slots allocated for repetitions of uplink data associated with the PUSCH transmission, and a numerical quantity of slots in the first portion of slots is based on a length of the at least one OCC sequence. Additionally, or alternatively, respective slots of the first portion of slots are associated with a same symbol allocation, and the respective slots of the first portion of slots are associated with a same OCC sequence. Additionally, or alternatively, the UE 2000 may be configured to support determining to transmit at least one repetition based on at least one slot of the second portion of slots being within an inactive period of a discontinuous reception cycle associated with the UE and at least one slot of the first portion of slots being within an active period of the discontinuous reception cycle associated with the UE, or determining to cancel transmission of at least one repetition based on at least one slot of the second portion of slots being within an active period of a discontinuous reception cycle associated with the UE and at least one slot of the first portion of slots being within an inactive period of the discontinuous reception cycle associated with the UE.

Additionally, or alternatively, a length of the at least one OCC sequence is based on a length associated with the set of slots. Additionally, or alternatively, a slot offset associated with the set of slots is zero and respective RVs associated with the set of slots are a same value. Additionally, or alternatively, the UE 2000 may be configured to support determining, based on one or more of a length of the at least one OCC sequence or a numerical quantity of slots of the set of slots allocated for repetitions of uplink data associated with the PUSCH transmission, a TBS associated with the TB, where the at least one OCC sequence is associated with one or more of a time domain or a frequency domain. Additionally, or alternatively, the one or more parameters indicate the length of the at least one OCC sequence. Additionally, or alternatively, the one or more parameters include one or more of a first parameter that indicates multiple types of OCC sequences are enabled or disabled, a second parameter that indicates a length of the at least one OCC sequence, a third parameter that indicates an index of the at least one OCC sequence in a list of OCC sequences, or a fourth parameter that indicates one or more repetition types associated with repeating uplink data associated with the PUSCH transmission. Additionally, or alternatively, to receive the second signaling, the UE 2000 may be configured to support receiving at least one of RRC signaling, a DCI message, or a MAC-CE that indicates the one or more parameters. Additionally, or alternatively, to receive the second signaling, the UE 2000 may be configured to support receiving RRC signaling that indicates a set of parameters including the one or more parameters and receives a DCI message or MAC-CE that activates the one or more parameters.

Additionally, or alternatively, the UE 2000 may support at least one memory (e.g., the memory 2004) and at least one processor (e.g., the processor 2002) coupled with the at least one memory and configured to cause the UE to receive first signaling that schedules a PUSCH transmission including a TB over a set of slots, receive second signaling that indicates one or more parameters associated with at least one OCC sequence, apply the at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, and transmit the PUSCH transmission during the set of slots.

Additionally, the UE 2000 may be configured to support any one or combination of the at least one processor configured to cause the UE to repeat, based on a length of the at least one OCC sequence and the at least one OCC sequence being applied to the PUSCH transmission for the respective symbols of the respective slots of the set of slots, the at least one OCC sequence is applied to the PUSCH transmission for the respective slots of the set of slots, or both, uplink data associated with the PUSCH transmission on a set of frequency resources or time resources. Additionally, or alternatively, the at least one processor configured to cause the UE to repeat, based on a length of the at least one OCC sequence, uplink data associated with at least one of respective symbols of the set of slots or respective sets of symbols of the set of slots, and where the one or more parameters indicate for the UE to apply the at least one OCC sequence to the PUSCH transmission for the respective symbols of the respective slots of the set of slots, the PUSCH transmission includes a set of repetitions of the uplink data associated with the respective symbols or the respective sets of symbols, and the set of repetitions are associated with resource blocks in a frequency domain. Additionally, or alternatively, the set of slots is associated with a same OCC sequence, and the set of slots is associated with a same repetition type. Additionally, or alternatively, the one or more parameters indicate one or more of a set of OCC sequences corresponding to the respective slots of the set of slots or a set of repetition types corresponding to the respective slots of the set of slots.

Additionally, or alternatively, the one or more parameters indicate for the UE to apply the at least one OCC sequence to the PUSCH transmission for the respective slots of the set of slots based on the transport block or a CB associated with the transport block, the set of slots includes a first portion of slots allocated for the transport block and a second portion of slots allocated for repetitions of uplink data associated with the PUSCH transmission, and a numerical quantity of slots in the first portion of slots is based on a length of the at least one OCC sequence. Additionally, or alternatively, respective slots of the first portion of slots are associated with a same symbol allocation, and the respective slots of the first portion of slots are associated with a same OCC sequence. Additionally, or alternatively, the at least one processor configured to cause the UE to determine to transmit at least one repetition based on at least one slot of the second portion of slots being within an inactive period of a discontinuous reception cycle associated with the UE and at least one slot of the first portion of slots being within an active period of the discontinuous reception cycle associated with the UE, or determine to cancel transmission of at least one repetition based on at least one slot of the second portion of slots being within an active period of a discontinuous reception cycle associated with the UE and at least one slot of the first portion of slots being within an inactive period of the discontinuous reception cycle associated with the UE.

Additionally, or alternatively, a length of the at least one OCC sequence is based on a length associated with the set of slots. Additionally, or alternatively, a slot offset associated with the set of slots is zero and respective RVs associated with the set of slots are a same value. Additionally, or alternatively, the at least one processor configured to cause the UE to determine, based on one or more of a length of the at least one OCC sequence or a numerical quantity of slots of the set of slots allocated for repetitions of uplink data associated with the PUSCH transmission, a TBS associated with the TB, where the at least one OCC sequence is associated with one or more of a time domain or a frequency domain. Additionally, or alternatively, the one or more parameters indicate the length of the at least one OCC sequence. Additionally, or alternatively, the one or more parameters include one or more of a first parameter that indicates multiple types of OCC sequences are enabled or disabled, a second parameter that indicates a length of the at least one OCC sequence, a third parameter that indicates an index of the at least one OCC sequence in a list of OCC sequences, or a fourth parameter that indicates one or more repetition types associated with repeating uplink data associated with the PUSCH transmission. Additionally, or alternatively, to receive the second signaling, the at least one processor configured to cause the UE to receive at least one of RRC signaling, a DCI message, or a MAC-CE that indicates the one or more parameters. Additionally, or alternatively, to receive the second signaling, the at least one processor configured to cause the UE to receive RRC signaling that indicates a set of parameters including the one or more parameters and receives a DCI message or MAC-CE that activates the one or more parameters.

The controller 2006 may manage input and output signals for the UE 2000. The controller 2006 may also manage peripherals not integrated into the UE 2000. In some implementations, the controller 2006 may utilize an operating system such as iOS®, ANDROID®, WINDOWS®, or other operating systems. In some implementations, the controller 2006 may be implemented as part of the processor 2002.

In some implementations, the UE 2000 may include at least one transceiver 2008. In some other implementations, the UE 2000 may have more than one transceiver 2008. The transceiver 2008 may represent a wireless transceiver. The transceiver 2008 may include one or more receiver chains 2010, one or more transmitter chains 2012, or a combination thereof.

A receiver chain 2010 may be configured to receive signals (e.g., control information, data, packets) over a wireless medium. For example, the receiver chain 2010 may include one or more antennas to receive a signal over the air or wireless medium. The receiver chain 2010 may include at least one amplifier (e.g., a low-noise amplifier (LNA)) configured to amplify the received signal. The receiver chain 2010 may include at least one demodulator configured to demodulate the receive signal and obtain the transmitted data by reversing the modulation technique applied during transmission of the signal. The receiver chain 2010 may include at least one decoder for decoding the demodulated signal to receive the transmitted data.

A transmitter chain 2012 may be configured to generate and transmit signals (e.g., control information, data, packets). The transmitter chain 2012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2012 may also include at least one power amplifier configured to amplify the modulated signal to an appropriate power level suitable for transmission over the wireless medium. The transmitter chain 2012 may also include one or more antennas for transmitting the amplified signal into the air or wireless medium.

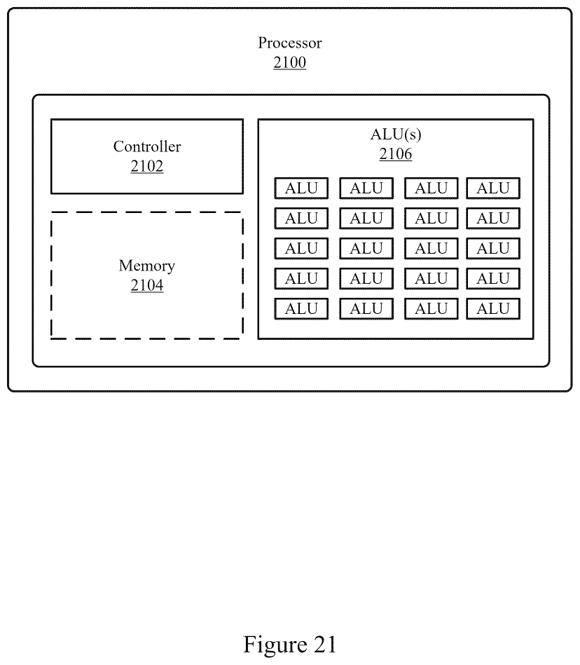

FIG. 21 illustrates an example of a processor 2100 in accordance with aspects of the present disclosure. The processor 2100 may be an example of a processor configured to perform various operations in accordance with examples as described herein. The processor 2100 may include a controller 2102 configured to perform various operations in accordance with examples as described herein. The processor 2100 may optionally include at least one memory 2104, which may be, for example, an L1/L2/L3 cache. Additionally, or alternatively, the processor 2100 may optionally include one or more arithmetic-logic units (ALUs) 2106. One or more of these components may be in electronic communication or otherwise coupled (e.g., operatively, communicatively, functionally, electronically, electrically) via one or more interfaces (e.g., buses).

The processor 2100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2102 may be configured to manage and coordinate various operations (e.g., signaling, receiving, obtaining, retrieving, transmitting, outputting, forwarding, storing, determining, identifying, accessing, writing, reading) of the processor 2100 to cause the processor 2100 to support various operations in accordance with examples as described herein. For example, the controller 2102 may operate as a control unit of the processor 2100, generating control signals that manage the operation of various components of the processor 2100. These control signals include enabling or disabling functional units, selecting data paths, initiating memory access, and coordinating timing of operations.

The controller 2102 may be configured to fetch (e.g., obtain, retrieve, receive) instructions from the memory 2104 and determine subsequent instruction(s) to be executed to cause the processor 2100 to support various operations in accordance with examples as described herein. The controller 2102 may be configured to track memory addresses of instructions associated with the memory 2104. The controller 2102 may be configured to decode instructions to determine the operation to be performed and the operands involved. For example, the controller 2102 may be configured to interpret the instruction and determine control signals to be output to other components of the processor 2100 to cause the processor 2100 to support various operations in accordance with examples as described herein. Additionally, or alternatively, the controller 2102 may be configured to manage flow of data within the processor 2100. The controller 2102 may be configured to control transfer of data between registers, ALUs 2106, and other functional units of the processor 2100.

The memory 2104 may include one or more caches (e.g., memory local to or included in the processor 2100 or other memory, such as RAM, ROM, DRAM, SDRAM, SRAM, MRAM, flash memory, etc. In some implementations, the memory 2104 may reside within or on a processor chipset (e.g., local to the processor 2100). In some other implementations, the memory 2104 may reside external to the processor chipset (e.g., remote to the processor 2100).

The memory 2104 may store computer-readable, computer-executable code including instructions that, when executed by the processor 2100, cause the processor 2100 to perform various functions described herein. The code may be stored in a non-transitory computer-readable medium such as system memory or another type of memory. The controller 2102 and/or the processor 2100 may be configured to execute computer-readable instructions stored in the memory 2104 to cause the processor 2100 to perform various functions. For example, the processor 2100 and/or the controller 2102 may be coupled with or to the memory 2104, the processor 2100, and the controller 2102, and may be configured to perform various functions described herein. In some examples, the processor 2100 may include multiple processors and the memory 2104 may include multiple memories. One or more of the multiple processors may be coupled with one or more of the multiple memories, which may, individually or collectively, be configured to perform various functions herein.

The one or more ALUs 2106 may be configured to support various operations in accordance with examples as described herein. In some implementations, the one or more ALUs 2106 may reside within or on a processor chipset (e.g., the processor 2100). In some other implementations, the one or more ALUs 2106 may reside external to the processor chipset (e.g., the processor 2100). One or more ALUs 2106 may perform one or more computations such as addition, subtraction, multiplication, and division on data. For example, one or more ALUs 2106 may receive input operands and an operation code, which determines an operation to be executed. One or more ALUs 2106 may be configured with a variety of logical and arithmetic circuits, including adders, subtractors, shifters, and logic gates, to process and manipulate the data according to the operation. Additionally, or alternatively, the one or more ALUs 2106 may support logical operations such as AND, OR, exclusive-OR (XOR), not-OR (NOR), and not-AND (NAND), enabling the one or more ALUs 2106 to handle conditional operations, comparisons, and bitwise operations.

The processor 2100 may support wireless communication in accordance with examples as disclosed herein. The processor 2100 may be configured to or operable to support at least one controller (e.g., the controller 2102) coupled with at least one memory (e.g., the memory 2104) and configured to cause the processor to receive first signaling that schedules a PUSCH transmission including a TB over a set of slots, receive second signaling that indicates one or more parameters associated with at least one OCC sequence, apply the at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, and transmit the PUSCH transmission during the set of slots.

Additionally, the processor 2100 may be configured to or operable to support any one or combination of the at least one controller configured to cause the processor to repeat, based on a length of the at least one OCC sequence and the at least one OCC sequence being applied to the PUSCH transmission for the respective symbols of the respective slots of the set of slots, the at least one OCC sequence is applied to the PUSCH transmission for the respective slots of the set of slots, or both, uplink data associated with the PUSCH transmission on a set of frequency resources or time resources. Additionally, or alternatively, the at least one controller configured to cause the processor to repeat, based on a length of the at least one OCC sequence, uplink data associated with at least one of the respective symbols of the set of slots or respective sets of symbols of the set of slots, and where the one or more parameters indicate for the UE to apply the at least one OCC sequence to the PUSCH transmission for the respective symbols of the respective slots of the set of slots, the PUSCH transmission includes a set of repetitions of the uplink data associated with the respective symbols or the respective sets of symbols, and the set of repetitions are associated with resource blocks in a frequency domain. Additionally, or alternatively, the set of slots is associated with a same OCC sequence, and the set of slots is associated with a same repetition type. Additionally, or alternatively, the one or more parameters indicate one or more of a set of OCC sequences corresponding to the respective slots of the set of slots or a set of repetition types corresponding to the respective slots of the set of slots.

Additionally, or alternatively, the one or more parameters indicate for the processor to apply the at least one OCC sequence to the PUSCH transmission for the respective slots of the set of slots based on the transport block or a CB associated with the transport block, the set of slots includes a first portion of slots allocated for the transport block and a second portion of slots allocated for repetitions of uplink data associated with the PUSCH transmission, and a numerical quantity of slots in the first portion of slots is based on a length of the at least one OCC sequence. Additionally, or alternatively, respective slots of the first portion of slots are associated with a same symbol allocation, and the respective slots of the first portion of slots are associated with a same OCC sequence. Additionally, or alternatively, the at least one controller configured to cause the processor to determine to transmit at least one repetition based on at least one slot of the second portion of slots being within an inactive period of a discontinuous reception cycle associated with the UE and at least one slot of the first portion of slots being within an active period of the discontinuous reception cycle associated with the processor, or determine to cancel transmission of at least one repetition based on at least one slot of the second portion of slots being within an active period of a discontinuous reception cycle associated with the processor and at least one slot of the first portion of slots being within an inactive period of the discontinuous reception cycle associated with the processor.

Additionally, or alternatively, a length of the at least one OCC sequence is based on a length associated with the set of slots. Additionally, or alternatively, a slot offset associated with the set of slots is zero and respective RVs associated with the set of slots are a same value. Additionally, or alternatively, the at least one controller configured to cause the processor to determine, based on one or more of a length of the at least one OCC sequence or a numerical quantity of slots of the set of slots allocated for repetitions of uplink data associated with the PUSCH transmission, a TBS associated with the TB, where the at least one OCC sequence is associated with one or more of a time domain or a frequency domain. Additionally, or alternatively, the one or more parameters indicate the length of the at least one OCC sequence. Additionally, or alternatively, the one or more parameters include one or more of a first parameter that indicates multiple types of OCC sequences are enabled or disabled, a second parameter that indicates a length of the at least one OCC sequence, a third parameter that indicates an index of the at least one OCC sequence in a list of OCC sequences, or a fourth parameter that indicates one or more repetition types associated with repeating uplink data associated with the PUSCH transmission. Additionally, or alternatively, to receive the second signaling, the at least one controller configured to cause the processor to receive at least one of RRC signaling, a DCI message, or a MAC-CE that indicates the one or more parameters. Additionally, or alternatively, to receive the second signaling, the at least one controller configured to cause the processor to receive RRC signaling that indicates a set of parameters including the one or more parameters and receive a DCI message or MAC-CE that activates the one or more parameters.

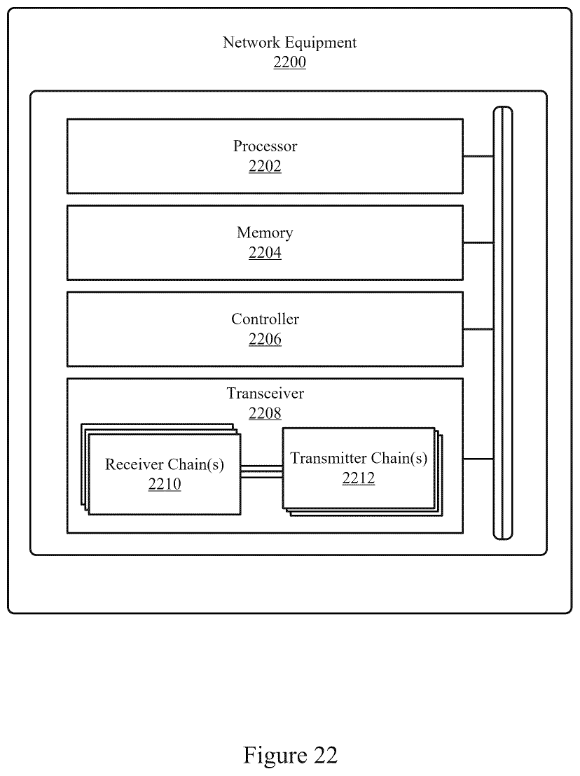

FIG. 22 illustrates an example of a NE 2200 in accordance with aspects of the present disclosure. The NE 2200 may include a processor 2202, a memory 2204, a controller 2206, and a transceiver 2208. The processor 2202, the memory 2204, the controller 2206, or the transceiver 2208, or various combinations thereof or various components thereof may be examples of means for performing various aspects of the present disclosure as described herein. These components may be coupled (e.g., operatively, communicatively, functionally, electronically, electrically) via one or more interfaces.

The processor 2202, the memory 2204, the controller 2206, or the transceiver 2208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2202 may include an intelligent hardware device (e.g., a general-purpose processor, a DSP, a CPU, an ASIC, an FPGA, or any combination thereof). In some implementations, the processor 2202 may be configured to operate the memory 2204. In some other implementations, the memory 2204 may be integrated into the processor 2202. The processor 2202 may be configured to execute computer-readable instructions stored in the memory 2204 to cause the NE 2200 to perform various functions of the present disclosure.

The memory 2204 may include volatile or non-volatile memory. The memory 2204 may store computer-readable, computer-executable code including instructions when executed by the processor 2202 cause the NE 2200 to perform various functions described herein. The code may be stored in a non-transitory computer-readable medium such as the memory 2204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2202 and the memory 2204 coupled with the processor 2202 may be configured to cause the NE 2200 to perform one or more of the functions described herein (e.g., executing, by the processor 2202, instructions stored in the memory 2204). For example, the processor 2202 may support wireless communication at the NE 2200 in accordance with examples as disclosed herein. The NE 2200 may be configured to or operable to support a means for transmitting first signaling that schedules a PUSCH transmission including a TB over a set of slots, transmitting second signaling that indicates one or more parameters associated with applying at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, and receiving the PUSCH transmission during the set of slots.

Additionally, the NE 2200 may be configured to or operable to support any one or combination of the uplink data associated with the PUSCH transmission is repeated on a set of frequency resources or time resources based on a length of the at least one OCC sequence and the at least one OCC sequence being applied to the PUSCH transmission for the respective symbols of the respective slots of the set of slots, the at least one OCC sequence is applied to the PUSCH transmission for the respective slots of the set of slots, or both. Additionally, or alternatively, uplink data associated with at least one of the respective symbols of the set of slots or respective sets of symbols of the set of slots is repeated based on a length of the at least one OCC sequence, the one or more parameters indicate to apply the at least one OCC sequence to the PUSCH transmission for the respective symbols of the respective slots of the set of slots, the PUSCH transmission includes a set of repetitions of the uplink data associated with the respective symbols or the respective sets of symbols, and the set of repetitions are associated with resource blocks in a frequency domain. Additionally, or alternatively, the set of slots is associated with a same OCC sequence, and the set of slots is associated with a same repetition type. Additionally, or alternatively, the one or more parameters indicate one or more of a set of OCC sequences corresponding to the respective slots of the set of slots or a set of repetition types corresponding to the respective slots of the set of slots.

Additionally, or alternatively, the one or more parameters indicate to apply the at least one OCC sequence to the PUSCH transmission for the respective slots of the set of slots based on the transport block or a CB associated with the transport block, the set of slots includes a first portion of slots allocated for the transport block and a second portion of slots allocated for repetitions of uplink data associated with the PUSCH transmission, and a numerical quantity of slots in the first portion of slots is based on a length of the at least one OCC sequence. Additionally, or alternatively, respective slots of the first portion of slots are associated with a same symbol allocation, and the respective slots of the first portion of slots are associated with a same OCC sequence. Additionally, or alternatively, a length of the at least one OCC sequence is based on a length associated with the set of slots. Additionally, or alternatively, a slot offset associated with the set of slots is zero and respective RVs associated with the set of slots are a same value.

Additionally, or alternatively, the one or more parameters indicate a length of the at least one OCC sequence. Additionally, or alternatively, the one or more parameters include one or more of a first parameter that indicates multiple types of OCC sequences are enabled or disabled, a second parameter that indicates a length of the at least one OCC sequence, a third parameter that indicates an index of the at least one OCC sequence in a list of OCC sequences, or a fourth parameter that indicates one or more repetition types associated with repeating uplink data associated with the PUSCH transmission. Additionally, or alternatively, to transmit the second signaling, the NE 2200 supports means for transmitting at least one of RRC signaling, a DCI message, or a MAC-CE that indicates the one or more parameters. Additionally, or alternatively, to transmit the second signaling, the NE 2200 supports means for transmitting RRC signaling that indicates a set of parameters including the one or more parameters and transmitting a DCI message or MAC-CE that activates the one or more parameters.

Additionally, or alternatively, the NE 2200 may support at least one memory (e.g., the memory 2204) and at least one processor (e.g., the processor 2202) coupled with the at least one memory and configured to cause the NE to transmit first signaling that schedules a PUSCH transmission including a TB over a set of slots, transmit second signaling that indicates one or more parameters associated with applying at least one OCC sequence to the PUSCH transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both, and receive the PUSCH transmission during the set of slots.

Additionally, the NE 2200 may be configured to support any one or combination of the uplink data associated with the PUSCH transmission is repeated on a set of frequency resources or time resources based on a length of the at least one OCC sequence and the at least one OCC sequence being applied to the PUSCH transmission for the respective symbols of the respective slots of the set of slots, the at least one OCC sequence is applied to the PUSCH transmission for the respective slots of the set of slots, or both. Additionally, or alternatively, uplink data associated with at least one of the respective symbols of the set of slots or respective sets of symbols of the set of slots is repeated based on a length of the at least one OCC sequence, the one or more parameters indicate to apply the at least one OCC sequence to the PUSCH transmission for the respective symbols of the respective slots of the set of slots, the PUSCH transmission includes a set of repetitions of the uplink data associated with the respective symbols or the respective sets of symbols, and the set of repetitions are associated with resource blocks in a frequency domain. Additionally, or alternatively, the set of slots is associated with a same OCC sequence, and the set of slots is associated with a same repetition type. Additionally, or alternatively, the one or more parameters indicate one or more of a set of OCC sequences corresponding to the respective slots of the set of slots or a set of repetition types corresponding to the respective slots of the set of slots.

Additionally, or alternatively, the one or more parameters indicate to apply the at least one OCC sequence to the PUSCH transmission for the respective slots of the set of slots based on the transport block or a CB associated with the transport block, the set of slots includes a first portion of slots allocated for the transport block and a second portion of slots allocated for repetitions of uplink data associated with the PUSCH transmission, and a numerical quantity of slots in the first portion of slots is based on a length of the at least one OCC sequence. Additionally, or alternatively, respective slots of the first portion of slots are associated with a same symbol allocation, and the respective slots of the first portion of slots are associated with a same OCC sequence. Additionally, or alternatively, a length of the at least one OCC sequence is based on a length associated with the set of slots. Additionally, or alternatively, a slot offset associated with the set of slots is zero and respective RVs associated with the set of slots are a same value.

Additionally, or alternatively, the one or more parameters indicate a length of the at least one OCC sequence. Additionally, or alternatively, the one or more parameters include one or more of a first parameter that indicates multiple types of OCC sequences are enabled or disabled, a second parameter that indicates a length of the at least one OCC sequence, a third parameter that indicates an index of the at least one OCC sequence in a list of OCC sequences, or a fourth parameter that indicates one or more repetition types associated with repeating uplink data associated with the PUSCH transmission. Additionally, or alternatively, to transmit the second signaling, the at least one processor is configured to transmit at least one of RRC signaling, a DCI message, or a MAC-CE that indicates the one or more parameters. Additionally, or alternatively, to transmit the second signaling, the at least one processor is configured to transmit RRC signaling that indicates a set of parameters including the one or more parameters and transmit a DCI message or MAC-CE that activates the one or more parameters.

The controller 2206 may manage input and output signals for the NE 2200. The controller 2206 may also manage peripherals not integrated into the NE 2200. In some implementations, the controller 2206 may utilize an operating system such as iOS®, ANDROID®, WINDOWS®, or other operating systems. In some implementations, the controller 2206 may be implemented as part of the processor 2202.

In some implementations, the NE 2200 may include at least one transceiver 2208. In some other implementations, the NE 2200 may have more than one transceiver 2208. The transceiver 2208 may represent a wireless transceiver. The transceiver 2208 may include one or more receiver chains 2210, one or more transmitter chains 2212, or a combination thereof.

A receiver chain 2210 may be configured to receive signals (e.g., control information, data, packets) over a wireless medium. For example, the receiver chain 2210 may include one or more antennas to receive a signal over the air or wireless medium. The receiver chain 2210 may include at least one amplifier (e.g., a low-noise amplifier (LNA)) configured to amplify the received signal. The receiver chain 2210 may include at least one demodulator configured to demodulate the receive signal and obtain the transmitted data by reversing the modulation technique applied during transmission of the signal. The receiver chain 2210 may include at least one decoder for decoding the demodulated signal to receive the transmitted data.

A transmitter chain 2212 may be configured to generate and transmit signals (e.g., control information, data, packets). The transmitter chain 2212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2212 may also include at least one power amplifier configured to amplify the modulated signal to an appropriate power level suitable for transmission over the wireless medium. The transmitter chain 2212 may also include one or more antennas for transmitting the amplified signal into the air or wireless medium.

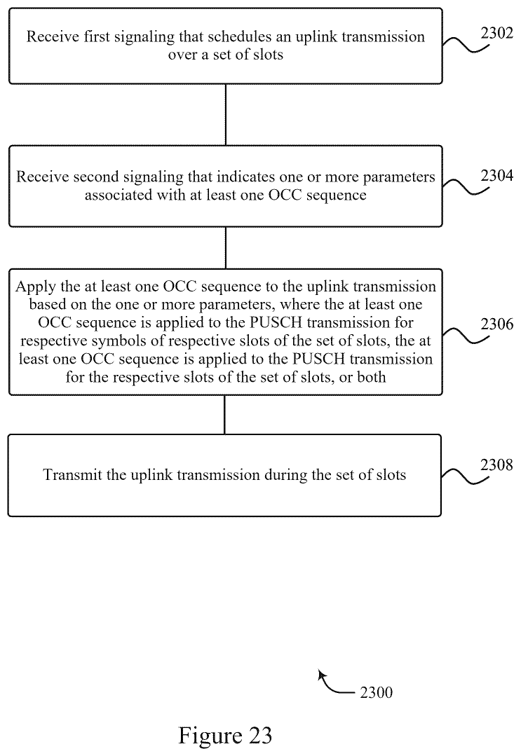

FIG. 23 illustrates a flowchart of a method 2300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 2302, the method may include receiving first signaling that schedules an uplink transmission over a set of slots. The operations of 2302 may be performed in accordance with examples as described herein. In some implementations, aspects of the operations of 2302 may be performed by a UE as described with reference to FIG. 20.

At 2304, the method may include receiving second signaling that indicates one or more parameters associated with at least one OCC sequence. The operations of 2304 may be performed in accordance with examples as described herein. In some implementations, aspects of the operations of 2304 may be performed by a UE as described with reference to FIG. 20.

At 2306, the method may include applying the at least one OCC sequence to the uplink transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both. The operations of 2306 may be performed in accordance with examples as described herein. In some implementations, aspects of the operations of 2306 may be performed by a UE as described with reference to FIG. 20.

At 2308, the method may include transmitting the uplink transmission during the set of slots. The operations of 2308 may be performed in accordance with examples as described herein. In some implementations, aspects of the operations of 2308 may be performed a UE as described with reference to FIG. 20.

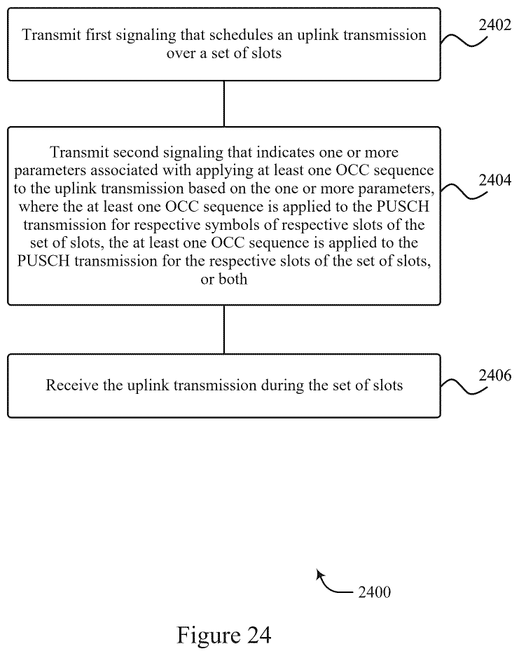

FIG. 24 illustrates a flowchart of a method 2400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 2402, the method may include transmitting first signaling that schedules an uplink transmission over a set of slots. The operations of 2402 may be performed in accordance with examples as described herein. In some implementations, aspects of the operations of 2402 may be performed by a NE as described with reference to FIG. 22.

At 2404, the method may include transmitting second signaling that indicates one or more parameters associated with applying at least one OCC sequence to the uplink transmission based on the one or more parameters, wherein the at least one OCC sequence is applied to the PUSCH transmission for respective symbols of respective slots of the set of slots, the at least one OCC sequence is applied to the PUSCH transmission for the respective slots of the set of slots, or both. The operations of 2404 may be performed in accordance with examples as described herein. In some implementations, aspects of the operations of 2404 may be performed by a NE as described with reference to FIG. 22.

At 2406, the method may include receiving the uplink transmission during the set of slots. The operations of 2406 may be performed in accordance with examples as described herein. In some implementations, aspects of the operations of 2406 may be performed by a NE as described with reference to FIG. 22.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive first signaling that schedules a physical uplink shared channel (PUSCH) transmission comprising a transport block (TB) over a plurality of slots;
receive second signaling that indicates one or more parameters associated with at least one orthogonal cover code (OCC) sequence;
apply the at least one OCC sequence to the PUSCH transmission based at least in part on the one or more parameters, wherein the at least one OCC sequence is applied to the PUSCH transmission for respective symbols of respective slots of the plurality of slots, the at least one OCC sequence is applied to the PUSCH transmission for the respective slots of the plurality of slots, or both; and
transmit the PUSCH transmission during the plurality of slots.

2. The UE of claim 1, wherein the at least one processor is further configured to cause the UE to repeat, based at least in part on a length of the at least one OCC sequence and the at least one OCC sequence being applied to the PUSCH transmission for the respective symbols of the respective slots of the plurality of slots, the at least one OCC sequence being applied to the PUSCH transmission for the respective slots of the plurality of slots, or both, uplink data associated with the PUSCH transmission on a plurality of frequency resources or time resources.

3. The UE of claim 1, wherein the at least one processor is further configured to cause the UE to repeat, based at least in part on a length of the at least one OCC sequence, uplink data associated with at least one of the respective symbols of the plurality of slots or respective sets of symbols of the plurality of slots, and wherein:
the one or more parameters indicate for the UE to apply the at least one OCC sequence to the PUSCH transmission for the respective symbols of the respective slots of the plurality of slots;
the PUSCH transmission comprises a plurality of repetitions of the uplink data associated with the respective symbols or the respective sets of symbols; and
the plurality of repetitions are associated with resource blocks in a frequency domain.

4. The UE of claim 3, wherein:
the plurality of slots is associated with a same OCC sequence; and
the plurality of slots is associated with a same repetition type.

5. The UE of claim 3, wherein the one or more parameters indicate one or more of a plurality of OCC sequences corresponding to the respective slots of the plurality of slots or a plurality of repetition types corresponding to the respective slots of the plurality of slots.

6. The UE of claim 1, wherein:
the one or more parameters indicate for the UE to apply the at least one OCC sequence to the PUSCH transmission for the respective slots of the plurality of slots based at least in part on the transport block or a code block associated with the transport block;
the plurality of slots comprises a first portion of slots allocated for the transport block and a second portion of slots allocated for repetitions of uplink data associated with the PUSCH transmission; and
a numerical quantity of slots in the first portion of slots is based at least in part on a length of the at least one OCC sequence.

7. The UE of claim 6, wherein:
respective slots of the first portion of slots are associated with a same symbol allocation; and
the respective slots of the first portion of slots are associated with a same OCC sequence.

8. The UE of claim 6, wherein the at least one processor is further configured to cause the UE to:
determine to transmit at least one repetition based at least in part on at least one slot of the second portion of slots being within an inactive period of a discontinuous reception cycle associated with the UE and at least one slot of the first portion of slots being within an active period of the discontinuous reception cycle associated with the UE; or
determine to cancel transmission of at least one repetition based at least in part on at least one slot of the second portion of slots being within an active period of a discontinuous reception cycle associated with the UE and at least one slot of the first portion of slots being within an inactive period of the discontinuous reception cycle associated with the UE.

9. The UE of claim 1, wherein a length of the at least one OCC sequence is based at least in part on a length associated with the plurality of slots.

10. The UE of claim 1, wherein a slot offset associated with the plurality of slots is zero and respective redundancy versions associated with the plurality of slots are a same value.

11. The UE of claim 1, wherein the at least one processor is further configured to cause the UE to determine, based at least in part on one or more of a length of the at least one OCC sequence or a numerical quantity of slots of the plurality of slots allocated for repetitions of uplink data associated with the PUSCH transmission, a TB size (TBS) associated with the TB, wherein the at least one OCC sequence is associated with one or more of a time domain or a frequency domain.

12. The UE of claim 11, wherein the one or more parameters indicate the length of the at least one OCC sequence.

13. The UE of claim 1, wherein the one or more parameters comprise one or more of a first parameter that indicates multiple types of OCC sequences are enabled or disabled, a second parameter that indicates a length of the at least one OCC sequence, a third parameter that indicates an index of the at least one OCC sequence in a list of OCC sequences, or a fourth parameter that indicates one or more repetition types associated with repeating uplink data associated with the PUSCH transmission.

14. The UE of claim 1, wherein to receive the second signaling, the at least one processor is configured to cause the UE to receive at least one of radio resource control (RRC) signaling, a downlink control information (DCI) message, or a medium access control-control element (MAC-CE) that indicates the one or more parameters.

15. The UE of claim 1, wherein to receive the second signaling, the at least one processor is configured to cause the UE to:
receive radio resource control (RRC) signaling that indicates a plurality of parameters comprising the one or more parameters; and
receive a downlink control information (DCI) message or medium access control-control element (MAC-CE) that activates the one or more parameters.

16. A processor for wireless communication, comprising:
at least one controller coupled with at least one memory and configured to cause the processor to:
receive first signaling that schedules a physical uplink shared channel (PUSCH) transmission comprising a transport block (TB) over a plurality of slots;
receive second signaling that indicates one or more parameters associated with at least one orthogonal cover code (OCC) sequence;
apply the at least one OCC sequence to the PUSCH transmission based at least in part on the one or more parameters, wherein the at least one OCC sequence is applied to the PUSCH transmission for respective symbols of respective slots of the plurality of slots, the at least one OCC sequence is applied to the PUSCH transmission for the respective slots of the plurality of slots, or both; and
transmit the PUSCH transmission during the plurality of slots.

17. A method performed by a user equipment (UE), the method comprising:
receiving first signaling that schedules a physical uplink shared channel (PUSCH) transmission comprising a transport block (TB) over a plurality of slots;
receiving second signaling that indicates one or more parameters associated with at least one orthogonal cover code (OCC) sequence;
applying the at least one OCC sequence to the PUSCH transmission based at least in part on the one or more parameters, wherein the at least one OCC sequence is applied to the PUSCH transmission for respective symbols of respective slots of the plurality of slots, the at least one OCC sequence is applied to the PUSCH transmission for the respective slots of the plurality of slots, or both; and
transmitting the PUSCH transmission during the plurality of slots.

18. A network equipment (NE) for wireless communication, comprising:
at least one memory; and
at least one processor coupled with the at least one memory and configured to cause the NE to:
transmit first signaling that schedules a physical uplink shared channel (PUSCH) transmission comprising a transport block (TB) over a plurality of slots;
transmit second signaling that indicates one or more parameters associated with applying at least one orthogonal cover code (OCC) sequence to the PUSCH transmission based at least in part on the one or more parameters, wherein the at least one OCC sequence is applied to the PUSCH transmission for respective symbols of respective slots of the plurality of slots, the at least one OCC sequence is applied to the PUSCH transmission for the respective slots of the plurality of slots, or both; and
receive the PUSCH transmission during the plurality of slots.

19. The NE of claim 18, wherein uplink data associated with the PUSCH transmission is repeated on a plurality of frequency resources or time resources based at least in part on a length of the at least one OCC sequence and the at least one OCC sequence being applied to the PUSCH transmission for the respective symbols of the respective slots of the plurality of slots, the at least one OCC sequence being applied to the PUSCH transmission for the respective slots of the plurality of slots.

20. The NE of claim 18, wherein:
uplink data associated with at least one of the respective symbols of the plurality of slots or respective sets of symbols of the plurality of slots is repeated based at least in part on a length of the at least one OCC sequence;
the one or more parameters indicate to apply the at least one OCC sequence to the PUSCH transmission for the respective symbols of the respective slots of the plurality of slots;
the PUSCH transmission comprises a plurality of repetitions of the uplink data associated with the respective symbols or the respective sets of symbols; and
the plurality of repetitions are associated with resource blocks in a frequency domain.
